(19) United States
(12) Patent Application Publication
(10) Pub. No.: US 2026/0097996 A1
(43) Pub. Date: Apr. 9, 2026

(54) CONCRETE ARTICLE, METHODS OF MAKING AND USING THE SAME

(71) Applicant: University of Southern California, Los Angeles, CA (US)

(72) Inventors: Xiaoying Pan, Los Angeles, CA (US); Bora Gencturk, Los Angeles, CA (US)

(21) Appl. No.: 19/349,203

(22) Filed: Oct. 3, 2025

Related U.S. Application Data
(60) Provisional application No. 63/703,561, filed on Oct. 4, 2024.

(51) Int. Cl. C04B 38/00; C04B 7/00; C04B 14/04; C04B 14/38; C04B 111/00

(52) U.S. Cl. CPC C04B 38/0054; C04B 7/00; C04B 14/04; C04B 14/38; C04B 2111/00017; C04B 2111/00275; C04B 2201/40; C04B 2201/52

(57) ABSTRACT

Disclosed herein is a concrete article comprising: a plurality of pores having an average pore diameter of less than 1 micron as measured using mercury intrusion porosimetry (MIP) with a pressure of less than 440 MPa and overall porosity of less than 15% measured using helium porosimetry, wherein the concrete article exhibits a gas permeability of 10⁻¹⁷ to 10⁻²² m2 as measured under steady-state conditions (with an upstream chamber pressure of 0.31 MPa and a downstream chamber pressure of less than 5 Pa) and is configured to substantially prevent a gas leak. Also disclosed are methods of making the same articles.

### CROSS-REFERENCE TO RELATED APPLICATIONS

This application claims the benefit of U.S. Provisional Application No. 63/703,561, filed Oct. 4, 2024, the entire disclosure of which is incorporated herein by reference.

### TECHNICAL FIELD

This application relates generally to concrete articles and methods of making and using the same.

### BACKGROUND

Concrete is one of the most utilized compounds in the world. The first concrete-like structures were built around 6500 BC. However, it was not until the late 1700s, beginning of 1800, that the more modern concrete compositions were invented and started to be widely utilized. Concrete is one of the most commonly used building materials (two billion tons in annual production). Its primary feature is the low cost and availability of raw materials. Commonly used concrete is a product resulting from the mixture of water with hydraulic cement and various aggregates, reacting in specific environmental conditions to achieve unique properties.

Concrete articles are commonly used in many applications. For example, concrete articles can be used in oil exploration, gas storage, nuclear fuel storage, etc. For example, cementitious materials are widely used in the plug and abandon (P & A) operations of wellbores. The sealing ability provided by those cementitious materials can play a vital role in preventing interzonal migration and surface leakage. However, there are concerns about the commonly used cementitious plugs, including shrinkage, cracking, long-term durability, poor resistance to hydrogen sulfide and carbon dioxide, and instability at high temperatures.

Thus, novel concrete compositions and articles that can overcome those challenges are still needed. This disclosure at least partially addresses these and other needs.

### SUMMARY

Disclosed herein is a concrete article comprising: a plurality of pores having an average pore diameter of less than 1 micron as measured using mercury intrusion porosimetry (MIP) with a pressure of less than 440 MPa and overall porosity of less than 15% measured using helium porosimetry, wherein the concrete article exhibits a gas permeability of 10⁻¹⁷ to 10⁻²² m² as measured under steady-state conditions (with an upstream chamber pressure of 0.31 MPa and a downstream chamber pressure of less than 5 Pa) and is configured to substantially prevent a gas leak.

In still further aspects, the disclosed herein concrete article is formed from a composition comprising an amount of a binder composition and an amount of water, wherein the binder composition comprises a hydraulic cement and an amount of a further cementitious material, and wherein a weight ratio of water to the binder is from 0.1 to less than 0.35.

In yet still further aspects, the concrete article is a ground-hole article. In yet still further aspects, the concrete article is a wellbore article. In yet still further aspects, the concrete article is a component of a gas storage facility. In yet still further aspects, the concrete article is a radioactive material storage or a part of a nuclear component or facility.

Still further disclosed herein is a method of making any of the disclosed herein articles. In such aspects, the method comprises mixing a binder composition with an amount of water to form a slurry, wherein the binder composition comprises an amount of cement and cementitious materials, and wherein a weight ratio of water to the binder composition is from 0.1 to less than 0.35.

Also disclosed is a concrete article comprising: a composition comprising: (a) a binder composition comprising: (i) 1 part by weight of a hydraulic cement; and (ii) 0.15 to 0.4 parts by weight of a cementitious material based the weight of the hydraulic cement; and b) optionally 0.1 to 0.35 parts by weight of a filler based on the weight of the hydraulic cement; c) 0-1 parts by weight of aggregates based on the weight of the hydraulic cement, wherein the aggregates have an average size of greater than 0 to equal to or less than 2 mm; d) 0.1-0.35 parts by weight of water based on the weight of the binder composition; e) greater than zero to less than 0.15 parts by weight of one or more active agents based on the weight of binder composition; and f) less than 5% by volume of total material volume of a plurality of fibers, wherein the concrete article has a plurality of pores having an average pore diameter of less than 1 micron as measured using mercury intrusion porosimetry (MIP) with a pressure less than 440 MPa and an overall porosity of less than 15% measured using helium porosimetry.

Still further disclosed herein is a composition comprising: (a) 1 part by weight of a hydraulic cement (b) 0.15-0.4 parts by weight based on the weight of the hydraulic of a cement additive comprising silica fume, fly ash, slag, metakaolin, bentonite, silica powder, rice husk ash, calcined shale or a combination thereof; (c) 0-1 parts by weight of aggregates based on the weight of the hydraulic cement, wherein the aggregates comprise: (i) 0.08-0.15 parts by weight of aggregates having an average particle size equal to or less than 250 μm measured based on ASTM C33/C33M; (ii) 0.28-0.4 parts by weight of aggregates having an average particle size equal to or less than 600 μm measured based on ASTM C33/C33M; and (iii) 0.45-0.75 parts by weight of aggregates having an average particle size equal to or less than 4.75 mm measured based on ASTM C33/C33M; (d) 0.1-0.35 parts by weight of water based on the weight of the binder composition comprised of a) and b); (e) greater than zero to less than 5% by volume of total material volume of a plurality of fibers; and (f) 0-0.15 parts by weight of one or more reactive agents based on the weight of the hydraulic cement.

Also disclosed are articles comprising the disclosed herein compositions.

Still further disclosed herein is a wellbore construction or plug comprising any of the disclosed herein articles or compositions. Still further disclosed herein is a gas storage facility comprising any of the disclosed herein articles or compositions. Still further disclosed herein is a radioactive material storage or a part of a nuclear component or facility comprising any of the disclosed herein articles or compositions.

In accordance with the purposes of the disclosed materials, compounds, compositions, and methods, as embodied and broadly described herein, the disclosed subject matter, in one aspect, relates to compounds and compositions and methods for preparing and using such compounds and compositions.

Additional advantages will be set forth in part in the description that follows and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 depicts a particle size distribution of coarse, fine, and very fine sand used in one aspect.

FIG. 2 depicts particle size distributions of aggregates used in in one aspect.

FIG. 3 depicts exemplary schematics for forming the article in one aspect.

FIG. 4 depicts an illustration of an exemplary porosity measurement using a custom helium porosimeter in one aspect.

FIG. 5 depicts an exemplary procedure for measuring porosity using a custom helium porosimeter in one aspect.

FIG. 6 depicts a pressure and temperature change over time during an exemplary helium porosimetry test in one aspect.

FIG. 7 depicts an exemplary illustration of the X-ray micro-CT system in one aspect.

FIG. 8 depicts an exemplary illustration of a gas permeability setup in one aspect.

FIG. 9 depicts an exemplary curve of downstream pressure versus time in one aspect.

FIG. 10 depicts an exemplary calibration of the threshold value in one aspect.

FIG. 11 depicts an exemplary illustration of pore connectivity and tortuosity in one aspect.

FIGS. 12A-12B depict an example of the conversion of a 3D graph for pathfinding using the 26-neighbor-connectivity criterion in one aspect. FIG. 12A shows 26-neighbor-connectivity criterion. FIG. 12B shows a conversion of a 3D image to a weighted unidirectional graph.

FIG. 13 depicts an example of fitting fractal dimension data in one aspect.

FIG. 14 depicts flowability results for traditional mortars and the concrete article in one aspect.

FIG. 15 depicts the compressive strength of traditional mortar and the concrete article at 28 days of age in one aspect.

FIG. 16 depicts porosity over time during helium porosimetry testing in one aspect.

FIG. 17 depicts Helium porosimetry results for traditional mortars and the concrete article in one aspect.

FIGS. 18A-18B depict exemplary MIP results for traditional mortars and the concrete article in one aspect. FIG. 18A shows the concrete article and FIG. 18B shows traditional mortars.

FIG. 19 depicts an exemplary pore size distribution of mortars and the concrete article from MIP in one aspect.

FIG. 20 depicts an exemplary gas permeability coefficient of traditional mortars and UHD-CMP in one aspect.

FIGS. 21A-21E show exemplary pore structure parameters obtained from micro-CT scan data in one aspect.

FIGS. 22A-22E show an exemplary relationship between the pore structure parameters obtained from micro-CT scan data and permeability in one aspect.

FIG. 23 depicts a comparison of measured porosity by different techniques according to one aspect.

FIGS. 24A-24C show a comparison of well conditions (FIG. 24A): (a-i) abandoned well, (a-ii) conventionally plugged well, and (a-iii) UHD-CMP-plugged well; close-up cross-sectional view of the UHD-CMP plug highlighting key components (FIG. 24B); and potential methane leakage pathways (FIG. 24C): (c-i) along the cement-steel interface, (c-ii) through the bulk cementitious matrix, and (c-iii) along the cement-formation interface.

FIG. 25 shows the particle size distributions of coarse, fine, and very fine sand.

FIG. 26 shows the particle size distribution of UHD-CMP mixtures compared to MMA packing model.

FIG. 27 shows the mixing and curing procedure for UHD-CMP.

FIG. 28 shows an illustration of the custom helium porosimeter used to measure the porosity of UHD-CMP or mortar samples.

FIGS. 29A-29B show a schematic of MIP: initial setup with UHD-CMP in penetrometer (FIG. 29A); and mercury intrusion under applied pressure. (FIG. 29B)

FIGS. 30A-30C show a schematic of the steady-state permeability test setup: overall apparatus configuration (FIG. 30A), specimen setup for measuring gas permeability of mortar and UHD-CMP samples (FIG. 30B), and specimen setup for measuring gas permeability at the UHD-CMP- or mortar-steel interface (FIG. 30C)

FIGS. 31A-31B show a schematic representation of the push-out test setup: testing configuration for the cement-steel interface (FIG. 31A), and testing configuration for the cement-sandstone interface (FIG. 31B).

FIG. 32 shows a schematic of the pull-off adhesion test setup to measure normal bond strength.

FIGS. 33A-33B show drying shrinkage strains over 90 days for conventional mortars (FIG. 33A) and UHD-CMP (FIG. 33B).

FIGS. 34A-34C show drying shrinkage strains over 90 days for UHD-CMP with MGO (FIG. 34A), CaO-based expansive agent (FIG. 34B), and SRA-based reducer (FIG. 34C).

FIG. 35 shows the average 90-day drying shrinkage strains for conventional mortars and UHD-CMP.

FIG. 36 shows Helium porosimetry results for conventional mortar and UHD-CMP samples under standard curing conditions (C1).

FIG. 37 shows Helium porosimetry results for conventional mortar and UHD-CMP samples under curing conditions (C1-C5).

FIG. 38 shows the pore size distribution of mortars and UHD-CMP based on MIP.

FIG. 39 shows the permeability coefficient of mortar samples and UHD-CMP under standard curing conditions (C1).

FIG. 40 shows the permeability coefficient of mortar samples and UHD-CMP under curing conditions (C1-C5).

FIG. 41 shows the permeability coefficient of the UHD-CMP-steel interface under curing conditions C1 and C2.

FIG. 42 shows 28-day compressive strength results for conventional mortars and UHD-CMP

FIG. 43 shows push-out stress-slip curves for the UHD-CMP-steel interface.

FIG. 44 shows the shear bond strength of conventional mortar and UHD-CMP bonded to steel under standard curing conditions (C1).

FIG. 45A-45B shows shear bond strength under curing conditions (C1-C5) for conventional mortars and unmodified UHD-CMP (FIG. 45A), and UHD-CMP modified with shrinkage-reducing admixtures (FIG. 45B).

FIG. 46 shows push-out results for bonding with sandstone

FIG. 47 shows the tensile bond strength of UHD-CMP under standard curing conditions (C1).

FIG. 48 shows the tensile bond strength of mortar and UHD-CMP with steel under curing conditions (C1-C5).

### DETAILED DESCRIPTION

The materials, compounds, compositions, articles, and methods described herein may be understood more readily by reference to the following detailed description of specific aspects of the disclosed subject matter, and the examples included therein.

Before the present materials, compounds, compositions, kits, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entirety are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings:

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The term “or” means “and/or.” Recitation of ranges of values is merely intended to serve as a shorthand method of referring individually to each separate value falling within the range unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

All disclosed values also include values that fall within ±10% variation from the disclosed value unless otherwise indicated or inferred. In other words, if a range of 1 to 10 is disclosed, then a range of about 1 to about 10 is disclosed. In such aspects, it is understood that the amount or value in question can be the exact value or a value that provides equivalent results or effects as recited in the claims or taught herein. That is, amounts, sizes, formulations, parameters, and other quantities and characteristics include both exact values but also approximate, larger, or smaller values as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘x, y, z, or less’ and should be interpreted to include the specific ranges of ‘x,’ ‘y,’ ‘z,’ about x, ‘about y,’ and ‘about z’ as well as the ranges of ‘less than x,’ ‘less than y, or ‘less than z,’ or ‘less than about x,’ ‘less than about y, and ‘less than about z.’ Likewise, the phrase ‘x, y, z, or greater’ should be interpreted to include the specific ranges of ‘x,’ ‘y,’ ‘z,’ ‘about x,’ ‘about y,’ and ‘about z’ as well as the ranges of ‘greater than x,’ greater than y,’ ‘greater than z,’ or ‘greater than about x,’ greater than about y,’ ‘greater than about z.’ In addition, the phrase “‘x’ to ‘y’,” where ‘x’ and ‘y’ are numerical values, also includes “about ‘x’ to about ‘y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5% but also include individual values (e.g., 1%, 2%, 3%, and 4%) and the sub-ranges (e.g., 0.5% to 1.1%; 5% to 2.4%; 0.5% to 3.2%, and 0.5% to 4.4%, and other possible sub-ranges) within the indicated range.

Recitation of ranges of values herein is merely intended to serve as a shorthand method of referring individually to each separate value recited or falling within the range unless otherwise indicated herein, and each separate value is incorporated into the specification as if it were individually recited. Ranges provided herein are understood to be shorthand for all of the values within the range. For example, a range of 1 to 50 is understood to include any number, or combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, the term “composition” is intended to encompass a product comprising the specified ingredients in the specified amounts, as well as any product that results, directly or indirectly, from a combination of the specified ingredients in the specified amounts.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether or not additional components are contained in the mixture.

A weight percent (wt. %) of a component, unless specifically stated to the contrary, is based on the total weight of the formulation or composition in which the component is included.

As used herein, “compound” is intended to refer to a chemical entity, whether as a solid, liquid, or gas, and whether in a crude mixture or isolated and purified.

As used herein, “composite” refers to a combination of two or more distinct constituent materials into one. The individual components, on an atomic level, remain separate and distinct within the finished structure. The materials may have different physical or chemical properties that, when combined, produce a material with characteristics different from the original components. In some embodiments, a composite may have at least two constituent materials that comprise the same empirical formula but are distinguished by different densities, crystal phases, or a lack of a crystal phase (i.e., an amorphous phase).

It is understood that if described materials can have various hydration states in a given compound formula unless otherwise noted, a description of the material includes all the hydration states. For example, and without limitations, compounds such as aluminum sulfate, Al₂(SO₄)₃, include anhydrous Al₂ (SO₄)₃, Al₂ (SO₄)₃·18H₂O, and any other hydrated forms or mixtures.

As used herein, the term or phrase “cement” refers to a composition or substance with one or more constituents that is capable of binding materials together once set. In certain aspects, cement can include a number of dry constituents chosen based on the desired ratio or class of cement to be produced. Thus, cement refers to the dry, pre-set composition unless the context clearly dictates otherwise, for example, in a wet cement slurry or in a cured cement material. It is further understood that the general term “cement” comprises hydraulic cement, non-hydraulic cement, or a combination thereof.

The term “hydraulic cement” refers to any inorganic cement that hardens or sets due to hydration. As used herein, the term “hydraulically-active” refers to properties of a cement material that allow the material to set in a manner like hydraulic cement, either with or without additional activation. Hydraulic cements, for instance, include Portland cements, aluminous cements, pozzolan cements, fly ash cements, and the like. Thus, for example, any of the oil well type cements of the class “A-H” as listed in the API Spec 10, (1st ed., 1982) are suitable hydraulic cements.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount. It is understood that this definition also includes the ranges when no word “about” is present.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition or based on any other calculations as disclosed. It is understood that this definition also includes the ranges when no word “about” is present.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to. It is understood that this definition also includes the ranges when no word “about” is present.

As used herein, the terms “substantially identical reference composition” and “substantially identical reference article” refer to a reference composition or article comprising substantially identical components in the absence of an inventive component. In another exemplary aspect, the term “substantially,” in, for example, the context “substantially identical reference composition” or “substantially identical reference article,” refers to a reference composition or an article comprising substantially identical components and wherein an inventive component is absent or is substituted with a common in the art component.

By “contact” or other forms of the word, such as “contacted” or “contacting,” it is meant to add, combine, or mix two or more compounds, compositions, or materials under appropriate conditions to produce a desired product or effect. The term “react” is sometimes used when “contacting” results in a chemical reaction.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Articles and Compositions

In certain aspects disclosed herein is a concrete article comprising: a plurality of pores having an average pore diameter of less than 1 micron, less than 900 nm, less than 800 nm, less than 700 nm, less than 600 nm, less than 500 nm, less than 400 nm, less than 300 nm, less than 200 nm, less than 100 nm, less than 50 nm, or less than 10 nm, as measured using mercury intrusion porosimetry (MIP) with a pressure less than 440 MPa. In still further aspects, the concrete articles disclosed herein can have overall porosity of less than 15%, less than 12%, less than 10%, less than 8%, or less than 5%, measured using helium porosimetry. In still further aspects, the concrete article disclosed herein can exhibit a gas permeability of 10⁻¹⁷ to 10⁻²² m², including exemplary values of 10⁻¹⁸, 10⁻¹⁹, 10⁻²⁰, or 10⁻²¹ m² (or 10⁻¹⁷ to 10⁻²¹ m², 10⁻¹⁷ to 10⁻²⁰ m², 10⁻¹⁷ to 10⁻¹⁹ m², 10⁻¹⁷ to 10⁻¹⁸ m², 10⁻¹⁸ to 10⁻²² m², 10⁻¹⁹ to 10⁻²² m², 10⁻²⁰ to 10⁻²² m², or 10⁻²¹ to 10⁻²² m²) as measured under steady-state conditions (with an upstream chamber pressure of 0.31 MPa and a downstream chamber pressure of less than 5 Pa) and is configured to substantially prevent a gas leak.

In still further aspects, the concrete article disclosed herein can be formed from any cement composition that results in the disclosed above structure.

In certain aspects, the cement comprises Portland cement, a basic ingredient of concrete, mortar, stucco, and non-specialty grout, which is a fine powder produced by heating limestone and clay minerals in a kiln to form clinker, grinding the clinker, and adding small amounts of other materials. Several types of Portland cement can be used, for example, API Class A, Class G, or Class H; Ordinary Portland Cement (OPC) Type I, Type II, Type III, Type IV, or Type V; or a combination thereof (in accordance with the ASTM C150 standard). Portland Cement Type Ia, Type IIa, and/or Type IIIa may also be used, which have the same composition as Types I, II, and III except that an air-entraining agent is ground into the mix (also in accordance with the ASTM C150 standard).

Yet in other aspects, the cement can also comprise hydraulic types of cement, Saudi Class G hydraulic cement, non-hydraulic types of cement, Portland fly ash cement, Portland Pozzolan cement, Portland silica fume cement, masonry types of cement, mortars, EMC types of cement, stuccos, plastic types of cement, expansive types of cement, white blended types of cement, Pozzolan-lime types of cement, slag-lime types of cement, supersulfated types of cement, calcium aluminate types of cement, calcium sulfoaluminate types of cement, geopolymer types of cement, Rosendale types of cement, polymer cement mortar, lime mortar, and/or pozzolana mortar.

It is understood that the cement can comprise a mixture of two or more different types of cement. For example, the cement can comprise a mixture of hydraulic cement and non-hydraulic cement. Yet, in other aspects, the cement can comprise mixtures of different hydraulic cements and/or different non-hydraulic cements.

Yet in still further aspects, the concrete article disclosed herein is formed from a composition comprising an amount of a binder composition and an amount of water. In such exemplary and unlimiting aspects, the binder composition can comprise a hydraulic cement and an amount of a further cementitious material. Yet in still further aspects, the composition comprises a weight ratio of water to the binder from 0.1 to less than 0.35, including exemplary values of 0.15, 0.2, 0.25, 0.3, and 0.34. It is understood that the weight ratio of water to the binder can fall between any two foregoing values or within the range formed by any two foregoing values. For example and without limitations, the weight ratio of the water to the binder can be 0.1 to 0.35, 0.1 to 0.34, 0.1 to 0.33, 0.1 to 0.32, 0.1 to 0.31, 0.1 to 0.30, 0.1 to 0.29, 0.1 to 0.28, 0.1 to 0.27, 0.1 to 0.26, 0.1 to 0.25, 0.1 to 0.24, 0.1 to 0.23, 0.1 to 0.22, 0.1 to 0.2, 0.1 to 0.15, 0.12 to 0.35, 0.15 to 0.35, 0.18 to 0.35, 0.2 to 0.35, 0.22 to 0.35, 0.25 to 0.35, 0.27 to 0.35, 0.3 to 0.35, and so on.

In certain aspects, it is understood that hydraulic cement can comprise any known in-the-art hydraulic cement suitable to form the desired article. Yet, in the other aspects, the hydraulic cement used herein comprises Type I/II ordinary Portland cement (OPC).

In still further aspects, the further cementitious material comprises silica fume, fly ash, metakaolin, bentonite, slag cement, rice husk ash, calcined shale, or any combination thereof.

It is understood that a weight ratio of hydraulic cement to the further cementitious material can be predetermined based on the desired structural properties of the article. In certain aspects, for example, and without limitations, the binder composition can comprise: (i) 1 part by weight of any of the disclosed herein hydraulic cements and (ii) 0.15 to 0.4 parts by weight of a further cementitious material based on the weight of the hydraulic cement. In such aspects, the further cementitious material can be present in 0.15 to 0.4 parts by weight, including exemplary values of 0.18, 0.2, 0.22, 0.25, 0.28, 0.3, 0.32, 0.35, and 0.38 parts by weight of the further cementitious material based the weight of the hydraulic cement. In still further aspects, the further cementitious material can be present in any amount that falls between any two foregoing values or within the range formed by any two foregoing values. For example, the further cementitious material can be present in 0.15 to 0.4, 0.15 to 0.38, 0.15 to 0.35, 0.15 to 0.32, 0.15 to 0.3, 0.15 to 0.28, 0.15 to 0.25, 0.15 to 0.22, 0.15 to 0.2, 0.15 to 0.18, 0.18 to 0.4, 0.2 to 0.4, 0.22 to 0.4, 0.25 to 0.4, 0.28 to 0.4, 0.3 to 0.4, 0.32 to 0.4, or 0.35 to 0.4 parts by weight of a further cementitious material based the weight of the hydraulic cement.

In still further aspects, the composition can further comprise an amount of aggregates having an average particle size less than or equal to 4.75 mm, less than or equal to 4.5 mm, less than or equal to 4.25 mm, less than or equal to 4 mm, less than or equal to 3.75 mm, less than or equal to 3.5 mm, less than or equal to 3.25 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, less than or equal to 900 μm, less than or equal to 800 μm, less than or equal to 700 μm, less than or equal to 600 μm, less than or equal to 500 μm, less than or equal to 400 μm, less than or equal to 300 μm, less than or equal to 200 μm, less than or equal to 100 μm, less than or equal to or 50 μm, where the particle size is measured according to ASTM C33/C33M.

It is understood that the aggregates can be classified based on the aggregate size as very fine, fine, and coarse.

In such exemplary and unlimiting aspects, the composition can comprise very fine aggregates having an average particle size less than or equal to 250 μm, less than or equal to 225 μm, less than or equal to 200 μm, less than or equal to 175 μm, less than or equal to 150 μm, less than or equal toμm, less than or equal to 125 μm, less than or equal to 100 μm, less than or equal to 75 μm, or less than or equal to 50 μm. In still further aspects, the very fine aggregates can have an average particle size of greater than 0 to 250 μm, 10 nm to 250 μm, 100 nm to 250 μm, 1 μm to 250 μm, 5 μm to 250 μm, 10 μm to 250 μm, 50 μm to 250 μm, 75 μm to 250 μm, 100 μm to 250 μm, 150 μm to 250 μm, 200 μm to 250 μm, 1 μm to 200 μm, 1 μm to 150 μm, 1 μm to 100 μm, 1 μm to 50 μm, and so on. It is understood that these particle sizes are measured according to AST C33/C33M.

In still further aspects, the composition can comprise fine aggregates having an average particle size less than or equal to 600 μm, less than or equal to 575 μm, less than or equal to 550 μm, less than or equal to 525 μm, less than or equal to 500 μm, less than or equal toμm, less than or equal to 475 μm, less than or equal to 450 μm, less than or equal to 425 μm, less than or equal to 400 μm, less than or equal to 375 μm, less than or equal to 350 μm, less than or equal to 325 μm, less than or equal to 300 μm, less than or equal to 275 μm, or less than or equal to 250 μm. In still further aspects, the fine aggregates can have an average particle size of greater than 250 to 600 μm, 275 nm to 600 μm, 300 nm to 600 μm, 350 μm to 600 μm, 400 μm to 600 μm, 450 μm to 600 μm, 500 μm to 600 μm, 250 to 550 μm, 250 to 500 μm, 250 to 450 μm, 250 to 400 μm, 250 to 350 μm, 250 to 300 μm, and so on. It is understood that these particle sizes are measured according to AST C33/C33M.

In still further aspects, the composition can comprise coarse aggregates having an average particle size less than or equal to 4.75 mm, less than or equal to 4.5 mm, less than or equal to 4.25 mm, less than or equal to 4 mm, less than or equal to 3.75 mm, less than or equal to 3.5 mm, less than or equal to 3.25 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, less than or equal to 900 μm, less than or equal to 800 μm, less than or equal to 700 μm, less than or equal to 600 μm. In still further aspects, the coarse aggregates can have an average particle size of greater than 600 μm to 4.75 mm, 800 μm to 4.75 mm, 1 mm to 4.75 mm, 1.25 mm to 4.75 mm, 1.5 mm to 4.75 mm, 1.75 mm to 4.75 mm, 2 mm to 4.75 mm, 2.25 mm to 4.75 mm, 2.5 mm to 4.75 mm, 2.75 mm to 4.75 mm, 3 mm to 4.75 mm, 3.5 mm to 4.75 mm, 4 mm to 4.75 mm, and so on. It is understood that these particle sizes are measured according to AST C33/C33M.

It is understood that the aggregates can be present in the composition in any amount and in any ratio to each other to form the desired article. In certain aspects, the aggregates disclosed herein can be present in 0-1, 0.1-1, 0.2-1, 0.3-1, 0.4-1, 0.5-1, 0.6-1, 0.7-1, 0.8-1, 0-0.9, 0-0.8, 0-0.7, 0-0.6, 0-0.5, 0-0.4, 0-0.2, 0.2-0.9, 0.5-0.8, 0.3-0.7, and so on, parts by weight of aggregates based on the weight of the hydraulic cement.

In certain aspects, the aggregates present in the composition can comprise 0.08-0.15, 0.08-0.14, 0.08-0.13, 0.08-0.12, 0.08-0.1, 0.09-0.15, 01-0.15, 0.12-0.15, and so on, parts by weight of aggregates having an average particle size equal to or less than 250 μm measured based on ASTM C33/C33M (or any other of very fine aggregates disclosed above). Yet in addition or in alternative, the aggregates present in the composition can comprise 0.28-0.4, 0.3-0.4, 0.32-0.4, 0.35-0.4, 0.38-0.4, 0.28-0.38, 0.28-0.35, 0.28-0.2, 0.28-0.3, and so on parts by weight of aggregates having an average particle size equal to or less than 600 μm measured based on ASTM C33/C33M (or any other of fine aggregates disclosed above). Yet in addition or in alternative, the aggregates present in the composition can comprise 0.45-0.75, 0.45-0.72, 0.45-0.7, 0.45-0.68, 0.45-0.65, 0.45-0.62, 0.45-0.6, 0.45-0.58, 0.45-0.55, 0.45-0.52, 0.45-0.5, 0.48-0.75, 0.5-0.75, 0.55-0.75, 0.58-0.75, 0.6-0.75, 0.65-0.75, and so on parts by weight of aggregates having an average particle size equal to or less than 4.75 mm measured based on ASTM C33/C33M (or any other of coarse aggregates disclosed above).

It is understood that aggregates themselves can be obtained from any known materials useful in concrete articles. For example, the aggregates can comprise river sand, masonry sand, limestone sand, lightweight porous sand, granite sand, quartz sand, silica sand, or any combination thereof.

In still further aspects, the composition that was used to form the disclosed herein article can further comprise a plurality of fibers. In such exemplary and unlimiting aspects, the plurality of fibers can comprise a metallic material, a polymeric material, a carbon material, a mineral material such as basalt or glass, a natural material such as wood based, or any combination thereof. In still further aspects, the plurality of fibers can comprise a polymeric material such as polyvinyl alcohol (PVA) fibers. In still further aspects, it is understood that the plurality of fibers can have any dimensions that would allow to obtain the desired composition. In certain aspects, the plurality of fibers can have a length of greater than 0 mm to 15 mm, 1-15 mm, 1-14 mm, 1-13 mm, 1-12 mm, 1-11 mm, 1-10 mm, 1-9 mm, 1-8 mm, 1-7 mm, 1-6 mm, 1-5 mm, 1-4 mm, 2-15 mm, 3-15 mm, 4-15 mm, 5-15 mm, 6-15 mm, 7-15 mm, 10⁻¹⁵ mm and so on. In still further aspects, the plurality of fibers can have a diameter of 10-100 μm, 15-100 μm, 20-100 μm, 30-100 μm, 40-100 μm, 50-100 μm, 60-100 μm, 70-100 μm, 10-90 μm, 10-80 μm, 10-70 μm, 10-60 μm, 10-50 μm, 10-40 μm, 10-30 μm, and so on.

In still further aspects, the plurality of fibers is substantially homogeneously distributed within the composition.

In yet still further aspects, if the plurality of fibers are present in the composition, they can be present in any amount. In certain exemplary and unlimiting aspects, the plurality of fibers can be present in greater than zero to less than 5%, less than 4%, less than 3%, less than 2%, less than 1%, less than 0.5%, less than 0.1% of a plurality of fibers by volume based on a total material volume. It is understood that the total material referenced to a total volume of the material being mixed/produced. Yet in still further aspects, the plurality of fibers can be present in an amount of 0.01% to 5%, 0.01% to 4.9%, 0.01% to 4.5%, 0.01% to 4%, 0.01% to 3.5%, 0.01% to 3%, 0.01% to 2.5%, 0.01% to 2%, 0.01% to 1.5%, 0.01% to 1%, 0.01% to 0.5%, 0.01% to 0.1%, 0.05% to 5%, 0.1% to 5%, 0.5% to 5%, 1% to 5%, 1.5% to 5%, 2% to 5%, 2.5% to 5%, 3% to 5%, and so on.

In still further aspects, the composition can further comprise an amount of active agents and/or reagents, fillers, or any combination thereof. In such exemplary and unlimiting aspects, the active agent and/or reagent can comprise a water reducer, a set retarder, a shrinkage-reducing admixture, a workability retaining admixture, viscosity adjusting admixture, or any combination thereof.

In certain aspects, the high-range water reducer can be polycarboxylate-based.

Some unlimiting examples of agents/reagents include Sika ViscoCrete-2110, SikaControl NS, Sika Stabilizer-300 SCC, Sika Stabilizer-4 R, Master Builders Solutions MasterLife CFA 007 and MasterLife SRA 035. If the active agents and/or reagents are present in such aspects, the amount of those materials can be greater than zero to less than 0.15, less than 0.12, less than 0.1, less than 0.08, less than 0.05, less than 0.01 parts by weight based on the weight of binder composition. In certain aspects, the amount of the agents and/or reagents can be between 0.001 to less than 0.15, 0.005 to less than 0.15, 0.01 to less than 0.15, 0.05 to less than 0.15, 0.1 to less than 0.15, 0.001 to less than 0.12, 0.001 to less than 0.1, 0.001 to less than 0.08, 0.001 to less than 0.05, 0.001 to less than 0.01 parts by weight based on the weight of binder composition.

In still further aspects, the filer can be present in the composition. In such exemplary and unlimiting aspects, the filler can comprise a silica powder, a limestone powder, a quartz powder, nano clay, nano calcium carbonate, or any combination thereof. It is understood that silica powder can have an average size from nanometers to micrometers. In yet still further aspects, if the filler is present, the filler can be in the amount of 0.1 to 0.35, 0.1-0.3, 0.1-0.25, 0.1-2, 0.1-0.15, 0.15-0.35, 0.2-0.35, 0.25-0.35, and so on parts by weight based on the weight of the hydraulic cement.

In still further aspects, disclosed herein is a composition comprising: (a) 1 part by weight of a hydraulic cement (b) 0.15-0.4 parts by weight based on the weight of the hydraulic of a cement additive comprising silica fume, fly ash, slag, metakaolin, bentonite, silica powder, rice husk ash, calcined shale or a combination thereof; (c) 0-1 parts by weight of aggregates based on the weight of the hydraulic cement, wherein the aggregates comprise: (i) 0.08-0.15 parts by weight of aggregates having an average particle size equal to or less than 250 μm measured based on ASTM C33/C33M; (ii) 0.28-0.4 parts by weight of aggregates having an average particle size equal to or less than 600 μm measured based on ASTM C33/C33M; and (iii) 0.45-0.75 parts by weight of aggregates having an average particle size equal to or less than 4.75 mm measured based on ASTM C33/C33M; (d) 0.1-0.35 parts by weight of water based on the weight of the binder composition comprised of a) and b); (e) greater than zero to less than 5% by volume of total material volume of a plurality of fibers; and (f) 0-0.15 parts by weight of one or more reactive agents based on the weight of the hydraulic cement. It is understood that any of the disclosed materials can be present in any of the disclosed above specific amounts or ranges.

In still further aspects, the concrete article disclosed herein can exhibit a compressive strength of greater than 60 MPa to 200 MPa, including exemplary values 70 MPa, 80 MPa, 90 MPa, 100 MPa, 110 MPa, 120 MPa, 130 MPa, 140 MPa, 150 MPA, 160 MPa, 170 MPa, 180 MPA, and 190 MPa, prepared, cured, and tested according to ASTM C109/C109M. In still further aspects, the article can exhibit a compressive strength that falls within any two foregoing values or within the range formed by any two foregoing values. For example, and without limitations, the compressive strength can be 60 MPa to 200 MPa, 80 MPa to 200 MPa, 100 MPa to 200 MPa, 120 MPa to 200 MPa, 150 MPa to 200 MPa, 180 MPa to 200 MPa, 60 MPa to 180 MPa, 60 MPa to 150 MPa, 60 MPa to 100 MPa, and so on.

In still further aspects, the concrete article can be a ground-hole article. Yet in still further aspects, the concrete article is a wellbore article. In still further aspects when the concrete is the wellbore article, such article can comprise a packing between a wellbore casing and an earth formation, a plug, or any combination thereof.

In still further aspects, the disclosed herein article is a component of a gas storage facility. Yet in still further aspects, the gas storage facility is configured to store one or more of natural gas, methane, propane, butane, carbon dioxide, or any combination thereof. In still further aspects, the gas storage facility is positioned at least partially underground.

In still further aspects, the concrete article is a radioactive material storage or a part of a nuclear component or facility.

Still further disclosed is a concrete article comprising: a composition comprising: (a) a binder composition comprising: (i) 1 part by weight of a hydraulic cement; and (ii) 0.15 to 0.4 parts by weight of a further cementitious material based the weight of the hydraulic cement; and b) optionally 0.1 to 0.35 parts by weight of a filler based on the weight of the hydraulic cement; c) 0-1 parts by weight of aggregates based on the weight of the hydraulic cement, wherein the aggregates have an average size of greater than 0 to equal to or less than 2 mm; d) 0.1-0.35 parts by weight of water based on the weight of the binder composition; e) greater than zero to less than 0.15 parts by weight of one or more active agents based on the weight of binder composition; and f) less than 5% by volume of total material volume of a plurality of fibers, wherein the concrete article has a plurality of pores having an average pore diameter of less than 1 micron as measured using mercury intrusion porosimetry (MIP) with a pressure less than 440 MPa and an overall porosity of less than 15% measured using helium porosimetry. It is understood that any of the disclosed amounts and materials can be used in this article.

Also disclosed herein is a wellbore comprising any of the disclosed herein articles. Also, in some aspects, disclosed is a gas storage facility comprising any of the articles disclosed herein. In still further aspects, disclosed is a radioactive material storage or a part of a nuclear component or facility comprising any of the disclosed articles herein.

### Methods

Also disclosed are methods of forming the described above concrete articles.

In certain aspects, the method comprises mixing a binder composition with an amount of water to form a slurry, wherein the binder composition comprises an amount of cement and cementitious materials, and wherein a weight ratio of water to the binder composition is from 0.1 to less than 0.35. Yet in still further aspects, the weight ratio of water to the binder composition is from 0.1 to less than 0.35, including exemplary values of 0.15, 0.2, 0.25, 0.3, and 0.34. It is understood that the weight ratio of water to the binder composition can fall between any two foregoing values or within the range formed by any two foregoing values. For example and without limitations, the weight ratio of the water to the binder composition can be 0.1 to 0.35, 0.1 to 0.34, 0.1 to 0.33, 0.1 to 0.32, 0.1 to 0.31, 0.1 to 0.30, 0.1 to 0.29, 0.1 to 0.28, 0.1 to 0.27, 0.1 to 0.26, 0.1 to 0.25, 0.1 to 0.24, 0.1 to 0.23, 0.1 to 0.22, 0.1 to 0.2, 0.1 to 0.15, 0.12 to 0.35, 0.15 to 0.35, 0.18 to 0.35, 0.2 to 0.35, 0.22 to 0.35, 0.25 to 0.35, 0.27 to 0.35, 0.3 to 0.35, and so on. It is understood that any of the disclosed above cements and cementitious materials, in any of the disclosed above amounts, can be used in the disclosed herein method steps.

In still further aspects, the binder composition is mixed with an amount of any of the disclosed above aggregates having an average particle size less than or equal to 4.75 mm (measured according to ASTM C33/C33M) prior to mixing with water. In such aspects, and as disclosed above, at least a portion of the amount of aggregates can have an average particle size equal to or less than 250 μm measured according to ASTM C33/C33M. Yet in other aspects, at least a portion of the amount of aggregates can have an average particle size equal to or less than 600 μm measured according to ASTM C33/C33M.

In still further aspects, the slurry further comprises a plurality of fibers. It is understood that any of the disclosed above plurality of fibers can be used (the plurality of fibers can be selected from the disclosed above materials, dimensions, etc.)

In still further aspects, the slurry further comprises an amount of active agents and/or reagents, fillers, or any combination thereof. Again, any of the disclosed above active agents and/or reagents, fillers, or any combination thereof can be present in any of the disclosed above amounts.

In still further aspects, the methods disclose steps where the plurality of fibers, the active agents and/or reagents, fillers, or any combination thereof are mixed with the binder composition prior to mixing with water, mixed with water prior to mixing it with the binder composition, or separately added to the slurry. While in other aspects, in the disclosed methods at least one of the active agents is added to the amount of water before mixing it with the binder composition. While yet still in further aspects, the plurality of fibers can be added to the slurry after mixing the binder composition with water.

In still further aspects, disclosed are methods steps where the plurality of fibers is added such that they are substantially homogeneously distributed within the slurry.

Still further, the method of forming of article further comprises disposing the slurry into a mold to form the article. Yet in such exemplary and unlimiting aspects, the step of disposing can comprise casting the slurry, pumping the slurry, or any combination thereof.

### Examples

The following examples are set forth below to illustrate the methods and results according to the disclosed subject matter. These examples are not intended to be inclusive of all aspects of the subject matter disclosed herein but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, the temperature is in ° C. or is at ambient temperature, and pressure is at or near atmospheric. There are numerous variations and combinations of reaction conditions, e.g., component concentrations, temperatures, pressures, and other reaction ranges and conditions, which can be used to optimize the product purity and yield obtained from the described process. Only reasonable and routine experimentation will be required to optimize such process conditions.

Wellbores serve as a transportation channel for materials extracted from the earth's crust (e.g., fossil oil, coal, and natural gas), energy (e.g., geothermal), or sequestrated carbon dioxide. At the end of the production, the wellbore needs to be plugged and abandoned (P & A) to seal the well permanently. However, leakage is commonly observed in plugged wells due to insufficiency of the plugging materials and approaches. Additionally, there are over 120,000 documented (and possibly many more undocumented) orphaned wells in the United States, whose responsibility is left with the state agencies (U.S. Department of the Interior n.d.). An orphaned well is defined as a well “that is not used for an authorized purpose and for which no operator can be located or the operator of which is unable to plug the well and remediate and reclaim the well site. (Orphaned Wells Program Office 2023)” The leakage of methane from abandoned and/or orphaned oil and gas wells (AOOGW) contributes to global warming. According to the U.S. Environmental Protection Agency (United States. Environmental Protection Agency. Office of Policy 2021), approximately 294 kilotons of methane are emitted from AOOGW wells every year. In addition, the leakage of other contaminants (e.g., underground saltwater, hydrogen sulfide, benzene, and arsenic, etc.) may pollute groundwater aquifers, surface water bodies, and shallow subsurface, which may negatively impact the human and ecosystem health (El Hachem and Kang 2023). Therefore, it is important to control the leakage from AOOGW due to environmental and health concerns.

Cementitious materials are widely used in the P & A operations (Aslani et al., 2022). The sealing ability provided by cementitious materials plays a vital role in preventing interzonal migration and surface leakage. However, there are concerns about the commonly used cementitious plugs, including shrinkage, cracking, long-term durability, poor resistance to hydrogen sulfide and carbon dioxide, and instability at high temperatures (Achang et al., 2020). These limitations result in leakage pathways for fluids and gases in AOOGW. Cementitious plug failure accounts for 33% of the leaking wells in the Gulf of Mexico (Davies et al. 2014). Watson and Bachu (Nowamooz et al. 2015) found that methane could leak from the target shale formation into the surficial aquifer within a few months after P & A operations. Mainguy et al. (Mainguy et al. 2007) showed that the main reason for the failure of conventional Class G cementitious plugs is their low tensile strength. Researchers are seeking innovative cement mortar formulations to address the limitations of traditional cementitious plugs. Several studies investigated the performance of geopolymers under downhole conditions. Nasvi et al. (Nasvi et al. 2013) measured the permeability of fly ash-based geopolymers for application in carbon dioxide storage wells. The geopolymer had lower carbon dioxide permeability (2×10⁻²¹ to 6×10⁻²⁰ m²) compared to traditional cementitious plugs (10⁻²⁰ to 10⁻¹¹ m², depending on the cement type, intrusion fluid type and the testing conditions). It is noted here that a comparison of the gas permeability of cementitious materials needs to be carefully made because of the large variation in the results depending on the test method used, and the conditions under which the material is tested.

As the water-to-binder ratio (w/b) decreases, cementitious materials attain denser microstructures and a lower permeability. However, the application of low w/b cementitious materials in oil and gas wells is very limited in the literature. Based on a search of the open literature, a study by Burroughs et al. (Burroughs et al. 2019) was identified in which only the rheological behavior of cementitious materials with a w/b ratio ranging from 0.45 to 0.2 was investigated. It was found that the shear rate index increases with the w/b ratio and the weight fraction of silica fume, indicating that the shear thinning is more obvious in mixtures with a low w/b ratio and a high silica fume content. The potential use of low w/b ratio cementitious materials for plugging AOOGW wells needs more investigation.

### Example 1

### Materials and Experimental Methods

### Binders and Aggregates

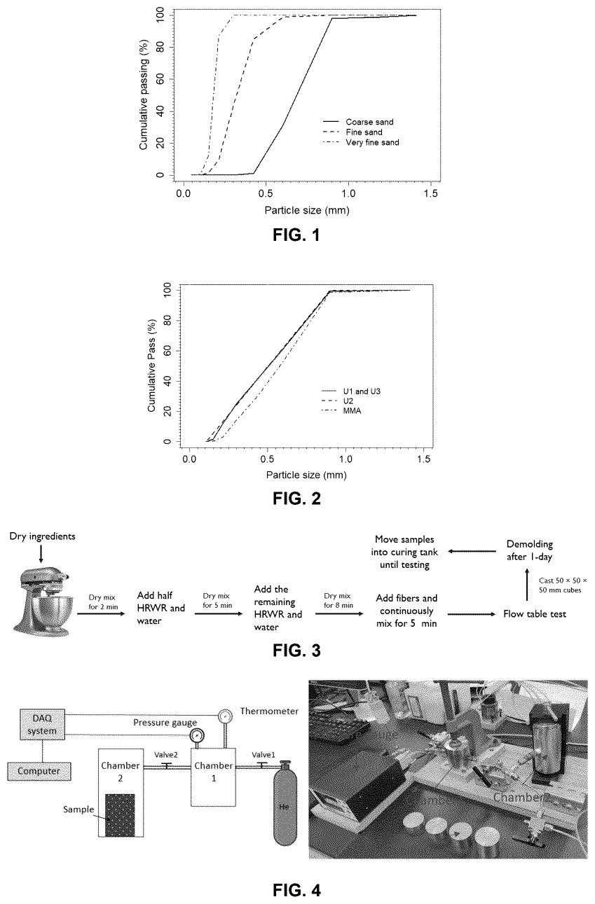

The materials used for mortar samples were ASTM C150 (ASTM 2022) Type I/II ordinary Portland cement (OPC) and coarse sand. To prepare the example articles, Type I/II OPC, two types of silica sand with different maximum particle sizes, the same coarse sand used for the mortar samples, and other additives were used. The silica sands used for the example articles are labeled here as fine and very fine sand. The three types of sands had maximum particle sizes of 1.19 mm, 600 μm, and 212 μm, respectively. The gradation of the aggregates (sands) is shown in FIG. 1. The specific gravities of the sands were respectively 2.65, 2.63, and 2.65. The fillers and additives used for example articles were densified silica fume (>95% SiO₂), silica powder, and a polycarboxylate-based high-range water reducer (HRWR). The silica fume was in conformance with ASTM C1240 (ASTM 2020a) with a median particle size of 0.114 μm. The silica powder had a specific gravity of 2.65 and a mean particle size of 5 μm. In addition, distributed PVA fibers with a length of 8.0±1.0 mm and a diameter of 38 μm were used in the example articles. The PVA fibers had a specific gravity of 1.3 and a tensile strength of 1600 MPa.

### Specimen Preparation

Three traditional mortars (M1, M2, and M3) and three example articles (U1, U2, U3). The mixture proportions for the traditional cement mortars and the example articles are shown in Table 1 and Table 2, respectively. In M1, M2, and M3, the w/b ratio was respectively 0.3, 0.4, and 0.5. In the mortar mixtures, the weight ratio of coarse sand to cement was 1. In the three example articles, a w/b ratio of 0.18 was adopted, and the dosage of the liquid-based high-range water reducer (HRWR) was fixed at 6% by weight of cementitious materials to provide good flowability. Distributed PVA fibers at a volume fraction of 0.5% were added to the example articles. The silica fume and silica powder were incorporated at varying percentages by weight of cement: 32.4%, 32.4%, and 37.4% in U1, U2, and U3, respectively. The aggregate (not including silica powder) size distributions of the three example articles are shown in FIG. 2. The aggregate size distributions in the example articles were designed to follow the Modified Andreasen and Andersen (MMA) particle packing theory, which is given by (Shi et al. 2021)

$$P ( d ) = \frac{d - {d}_{min}}{{d}_{max} - {d}_{min}} \qquad ( 1 )$$

where d is the diameter of the sand particles, and dₘₐₓ and dₘᵢₙ are, respectively, the maximum and minimum particle size in the mixture. Only fine and coarse sand were used in U1 and U3. Very fine sand was introduced to U2 for a better fit to the MMA particle packing. As shown in FIG. 2, the aggregate distribution of U2 was closer to the MMA particle distribution than those of U1 and U3.

TABLE 1
Mixture proportions of traditional mortars.

| | Amount (kg/m³) | | |
|---|---|---|---|
| | M1 | M2 | M3 |
| Cement | 1034.9 | 1034.9 | 1034.9 |
| Coarse Sand | 989.92 | 989.92 | 989.92 |
| Water | 310.46 | 413.95 | 517.44 |

TABLE 2
Mixture proportions of UHD-CMP.

| | Amount (kg/m³) | | |
|---|---|---|---|
| | U1 | U2 | U3 |
| Cement | 899.43 | 899.43 | 808.93 |
| Silica fume | 215.67 | 172.53 | 242.53 |
| Silica powder | 215.67 | 258.80 | 242.53 |
| Fine sand | 287.55 | 301.93 | 287.55 |
| Very fine sand | 0 | 86.27 | 0 |
| Coarse sand | 575.11 | 474.46 | 575.11 |
| Water | 245.28 | 245.28 | 245.28 |
| HRWR¹ | 60.03 | 60.03 | 60.03 |
| PVA fiber² | 5.45 | 5.45 | 5.45 |

¹High-range water reducer (HRWR).
²Polyvinyl alcohol (PVA).

The mixing procedure for example articles is presented in FIG. 3. First, all dry materials were mixed for 2 min. in a mortar mixer. Then, 50% of the water and HRWR were added to the mixer. The mixing was continued at 50 rpm until a homogenous mixture was obtained (roughly another 5 min.). The remaining 50% of the water and HRWR were added to the mixer and the mixing was continued at 150 rpm for around 8 min. until a slurry was formed. Then, PVA fibers were added slowly into the mixture while continuously mixing for another 5 min. The sand of different sizes and cementitious powders were simultaneously added to the mixer. Without wishing to be bound by any theory, it is assumed that this process increases friction between the particles and the mixer walls and the friction between the particles. As a result, the dispersion rate of water and superplasticizer is enhanced, thus reducing the slurry formation time. For the conventional mortars, the powder components were dry-mixed using the same mortar mixer at 50 rpm for 3 min, followed by a slow addition of water. After adding water, the materials were mixed for 6 min at 50 rpm and for 1 min at 150 rpm. After mixing, 50×50×50 mm cubes were cast and kept in normal laboratory conditions. The samples were demolded after 24 hours and placed into curing tanks with saturated lime water at 23±2° C.

### Flowability

The flowability of the six materials was measured following ASTM C1437-20 (ASTM 2020b). The fresh mortars and example articles were placed into a mini cone mold, which was placed on the flow table, and the surface was finished with a tamping rod. The cone mold was carefully removed, and the flow table was jolted 25 times. Two diameters in perpendicular directions were measured on the spreading sample, and the mean value was used as the flowability.

### Compressive Strength

Fifty-millimeter cubic samples were used for the compressive strength tests according to ASTM C109-20 (ASTM 2020c). The samples were loaded at a rate of 0.24 MPa/s until the load dropped to 60% of the peak value. The average value from three specimens was used as the compressive strength.

### Porosity Based on Helium Porosimetry

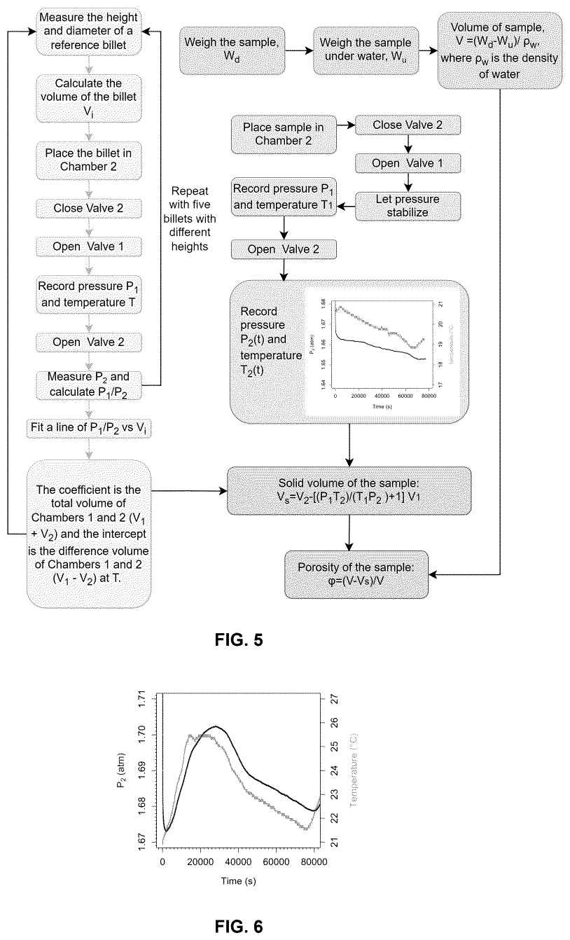

Porosity was measured using a custom helium porosimeter, as shown in FIG. 4. The helium porosimeter contains two chambers: an expansion chamber (Chamber 1) and a sample chamber (Chamber 2). Valves 1 and 2 control the gas flow throughout the system. The gas pressure is measured by a pressure sensor, which is connected to a data acquisition (DAQ) system. At the beginning of the test, Valve 2 is closed, and Valve 1 is open. The compressed helium in the cylinder flows into Chamber 1. Then, Valve 1 is closed, and the initial reading, P₁, of the pressure gauge, is recorded after the pressure is stabilized. Next, Valve 2 is opened, and the helium is allowed to flow from Chamber 1 into Chamber 2. The pressure of the system decreases as the volume of helium increases, which follows Boyle's law according to

$${P}_{1} {V}_{1} = {P}_{2} {V}_{2} \qquad ( 2 )$$

where P₁ is the initial pressure in Chamber 1, as defined earlier, V₁ is the volume of Chamber 1, P₂ is the pressure after Valve 2 is opened, and V₂=V₁+V_{c2}−V_{b}+Vₚ, with V_{c2} being the volume of Chamber 2, Vₚ being the bulk volume of the sample and Vₚ being the volume of the pores in the sample. Vₚ can be calculated using Eq. (2), which also requires the measurement of V₁ and V_{c2}. The measurement of V₁ and V_{c2} requires the calibration of the system, which is shown in yellow boxes in FIG. 5. The calibration was done using four stainless steel billets with known volumes at five different temperatures between 18° C. and 30° C. Different temperatures were used to take into consideration the thermal expansion of the system.

After the calibration, samples were placed inside Chamber 2, and the procedure shown in the blue boxes in FIG. 5 was followed to measure the pressure and temperature. For samples with tight pores, the helium diffuses into the sample at a very slow rate. Thus, the pressure needs to be recorded over a long period (around 5 h) to make sure the porosity can be obtained after the diffusion process. The pressure of the gas is very sensitive to temperature. If the temperature of the system is not controlled with a water bath, a temperature correction to the porosity needs to be made. Therefore, the temperature in the camber is also recorded during the test, and the pressure is corrected based on the ideal gas law. As seen in FIG. 6, the pressure is not stable without a temperature correction and correlates with the temperature readings. After the pressure and temperature recording, the volume of the specimens was measured according to the procedure shown in green boxes in FIG. 5. Finally, the porosity of the samples was calculated using the formulation in the pink boxes in FIG. 5.

### Porosity Based on Mercury Intrusion Porosimetry

The pore size distribution is measured by Mercury intrusion porosimetry (MIP), which is a widely used method for assessing the pore structure of cementitious materials. MIP relies on the assumption that the pore volume corresponding to different pore diameters relates to the volume of mercury intruded into the samples under varying pressure levels. The Washburn equation provides a relationship between the pressure and the pore size, which is given as follows,

$$r = - \frac{2 γ cos θ}{P} \qquad ( 3 )$$

where r is the radius of the pore in which mercury is being intruded, P is the applied pressure, γ is the surface tension (assumed to be 480 mN/m), and θ is the contact angle between the mercury and the pore surface.

An AutoPore IV 9500 mercury intrusion porosimeter was used for the measurements. The sample size was approximately 10×10×10 mm. Before testing, the samples were oven dried at 60° C. for 24 hours. The highest pressure in the mercury intrusion process was 414 MPa. With increasing mercury pressure, the diameter of pores from 3 nm to 360 μm was measured. θ=140° was used for the pore diameter calculation.

### Pore Distribution and Connectivity Based on Micro-Computed Tomography (CT) Scans

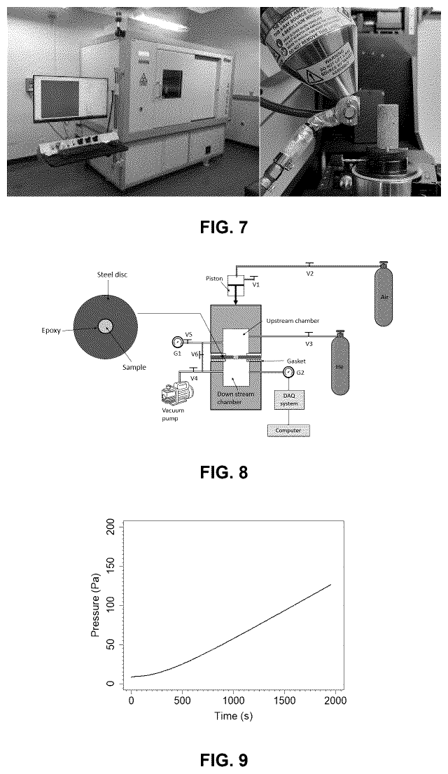

Micro-CT is a non-destructive 3D imaging technique using X-rays to characterize the internal structure of objects. The X-ray micro-CT system used here is shown in FIG. 7. Though MIP is a common technique for measuring concrete pore structure, it cannot provide comprehensive information to characterize the pores. One of the limitations of MIP is the ink-bottle effect, which results in the underestimation of the pore size. In addition, MIP measures the pore diameter in a pressurized environment, which may cause damage to the samples. Compared with MIP, micro-CT scans offer a comprehensive view of pore distribution, capturing both interconnected and isolated pores without requiring any prior drying preparation. A Nikon XT H 225 system with a transmission target was used for the micro-CT scans. Cylindrical samples were used to minimize beam hardening by having equal X-ray penetration length at all angles as the cylinder rotates about its longitudinal axis during the scan. Scans with a 2 μm resolution were achieved at an operating voltage of 147 kV, a current of 20μA, and with 4400 projections recorded during one full rotation of the sample. In each angle, four images were taken. The exposure time was 1.0 s per image. A flat panel detector with a resolution of 2000×2000 pixels was used.

### Gas Permeability

The gas permeability was measured by a steady-state permeability tester, shown in FIG. 8. The samples were glued into the center hole of a steel disc. The steel disc was placed in the setup to separate it into upstream and downstream chambers. A piston acts on top of the upper half of the setup to push it against the bottom half, providing compression and helping seal the two chambers. Before testing, valve V1 is closed and valve V2 is open such that the compressed air can flow to the piston and maintain a constant pressure of 0.69 MPa. At the beginning of the test, valves V4, V5, and V6 are opened while V3 is closed. Both the upstream and downstream chambers are vacuumed to 40 mtorr using the vacuum pump. Then, V4 and V6 are closed, and V3 is opened. The upstream pressure is maintained at around 0.31 MPa. The downstream pressure is recorded with a DAQ system. After testing, V2 is closed, and V1 is opened to release the pressure on the setup and change the sample. This setup can quickly measure the gas permeability of materials compared to traditional steady-state permeability testers because a high vacuum is applied to the downstream chamber, and a smaller sample size is used. To account for microstructural variability in the small samples, three samples were tested to obtain representative results. Without wishing to be bound by any theory, it is hypothesized that cementitious samples under high vacuum might lose free and bound water and produce irreversible changes in the microstructure. Again, without wishing to be bound by any theory, it is further hypothesized that gas permeability can be higher under vacuum conditions compared to pressurized conditions. As a result, the gas permeability results reported in this study are assumed to be higher than those where pressured systems are used.

The time derivative of gas volume in the downstream chamber, V, can be calculated according to

$$\frac{dV}{dt} = \frac{273 \times {V}_{d} \times ( \frac{dp}{dt} )}{101325 \times T} \qquad ( 4 )$$

where t is time,μ is the dynamic viscosity of helium, V_{d} is the volume of the downstream chamber, p is the downstream pressure, and T is the room temperature. The gas permeability coefficient, kᵥ, is calculated according to

$${k}_{v} = \frac{\frac{dV}{dt} h μ}{10000 \times A \times Δ P} \qquad ( 5 )$$

where h is the thickness of the sample, A is the cross-sectional area of the sample, and ΔP is the differential pressure between the upstream and downstream chambers (˜0.31 MPa). Because the change in the downstream pressure is very small (less than 2/1000 of the upstream pressure), ΔP is considered constant. FIG. 9 is an example of downstream pressure versus time, which is used to determine dp/dt for the calculation of gas permeability.

### Computational Methods Used in the Analysis of Micro-CT Scan Data

### Phase Identification

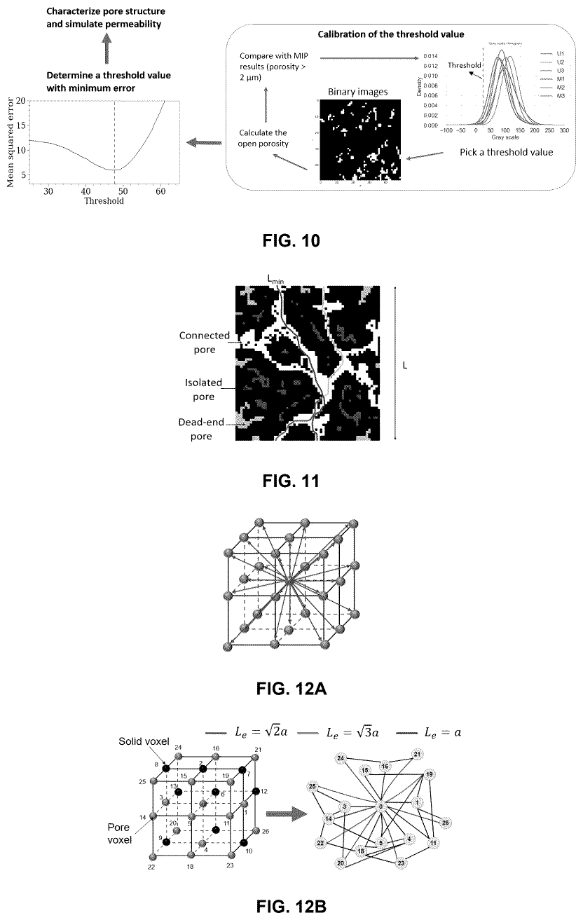

The 3-D reconstructed images from micro-CT scans included 3000×3000×3000 voxels. The volume of each voxel was 2.0×2.0×2.0 μm. The high computational cost and hardware limitations made it challenging to conduct calculations on the entire 3-D reconstructed image. A common method involves selecting a region of interest (ROI) and performing the calculations on the ROI. The X-ray images have different grey values for different components because the X-ray attenuation coefficients depend on the density of the component. The grey values of solid components are higher than those of the pores. Therefore, the components can be segmented by their grey values in the 3-D image. The spatial location and volumes of the components can also be determined. The scan data contains four variables, including coordinates at x, y, and z directions and the corresponding gray value. Each pixel consists of a gray-level value. A typical histogram of the gray level in the ROI is shown on the right in FIG. 10.

From the micro-CT scan images, different phases in the materials need to be identified. However, typical CT scans cannot conduct chemical analysis, and two components might have similar grey values despite having different chemical compositions. The brightness differences between material components are solely influenced by variations in the atomic mass or the density of the components. Using high resolution and good quality scan parameters, along with a knowledge of the material, differentiation of one component from another can be achieved. Nevertheless, and without being bound by any theory, it was suggested that the segmentation process plays an important role in separating the phases/materials (solids and pores in this study). Therefore, careful consideration is needed in the use of the segmentation method.

FIG. 10 presents the approach for the characterization of pore structure and the determination of the permeability in cementitious materials using the micro-CT scan data. Example histograms of the gray levels of the six samples (three mortar and three example articles) are shown in the rightmost pane. The global threshold method is used for performing image segmentation. A threshold value is denoted by a dashed vertical line in the histogram. A set of threshold values (from 25 to 65 with an increment of 0.01) was applied to all the samples, which transformed the grayscale images into binary images (solid and pores). During the binarization, a pore phase was assigned a value of 0 for the voxels with a grayscale number smaller than the threshold value, and a solid phase was assigned a value of 1 for the voxels with a grayscale number larger than the threshold value. These binary images serve as a quantitative representation of the open porosity within the samples. The calculated open porosity derived from the binary images was compared against the results obtained from MIP, which offers a standard for porosity quantification specifically for pore sizes exceeding 2 μm. This comparative analysis ensures the validity of the digital image processing technique against an established porosity measurement method, thus reinforcing the reliability of the image-based porosity assessment. The procedure commences with the determination of the mean squared error between the porosity calculated from the binary image stacks and the MIP data based on all of the six mixtures. For each mix, five binary image stacks were used. Each binary image stack contained information for a randomly selected different ROI in the sample having 100×100×100 voxels. Once the mean squared error is found for all threshold values, the optimal threshold value that minimizes the error, as illustrated by the curve in the graph on the left in FIG. 10, is selected. Once the optimal threshold value is found, the geometric information, such as the volume, surface area, and perimeter, can be quantitatively analyzed in the binary images for the five ROIs for each sample, which are described in the next section.

### Pore Structure Parameters

### Porosity

There are several parameters that can be used to characterize pores in 2D space, which include pore diameter and pore area, effective pore size, pore size based on two-point correlation function, and pore size based on granulometric distribution. However, it has been shown that these different definitions result in negligible differences in the porosity. Considering the ease of finding the necessary parameters, the area is typically used to characterize the size of 2D pores. For 3D pores, the pore size is determined by the pore volume. Here, after the segmentation of the images, the porosity, φ, was determined according to

$$φ = \frac{{V}_{p}}{{V}_{S}} \times 100 \% \qquad ( 6 )$$

where Vₚ is the total volume of pores, and Vₛ is the volume of the sample.

### Pore Connectivity and Tortuosity

There are many geometrically irregular pore bodies in a porous medium. Some of the pores are connected to the boundaries, while others are isolated internally or dead-ended, as shown in FIG. 11. The size of pores can vary from a few nanometers to a thousand micrometers. Additionally, the interface between the solid and a pore (the boundary between the black and white voxels in a CT image) is typically rough. Rough interfaces can create more tortuous paths for fluid transport, which are important to estimate the resistance to flow within the material. It is very challenging to develop a method that accurately describes the tortuosity. For these reasons, the tortuosity values have been calculated from different geometric methods. However, the results are often very different from the results of experimental measurements.

Here, to determine the connected pores, the micro-CT scan images were converted into graphs, as shown in FIGS. 12A-12B. In the graph, each node corresponds to a voxel in the CT scan image. The connections between two neighbor nodes are defined by the voxel connectivity, using the 26-neighbor-connectivity criterion as shown in FIG. 12A. The distance weight between the adjacent nodes in the graph is determined by the Euclidean distance between two neighboring void voxels in the binary image data. As shown in FIG. 12B, the weights were set equal to 1 for the six immediate neighboring nodes, \sqrt{2} for the 12 edge-center nodes, and \sqrt{2} for the eight corner nodes. The shortest path is the distance of the flow. It is defined as the shortest distance from any starting node on a surface to any ending node on the opposite surface. Dijkstra's algorithm (Fu et al. 2021) was used to find the shortest path. The shortest path search was repeated for each combination of all possible starting and ending voxels to identify all possible paths within the entire ROI.

Pore connectivity is defined as the ratio of connected porosity to total porosity. The connectivity, η, is obtained as

$$η = \frac{{φ}_{c}}{φ} \times 100 \% \qquad ( 7 )$$

where φ_{c} is the connected porosity, and φ is the porosity as defined earlier.

The tortuosity of concrete plays a crucial role in determining its permeability. The geometrical tortuosity is determined as the ratio of the length of the actual path a fluid takes through the pore structure to the straight-line distance. Previously, it was found that the path of the shortest connected pores is a good estimate of the effective flow path. The tortuosity, τ, is given by,

$$τ = \frac{{L}_{min}}{L} \qquad ( 8 )$$

where Lₘᵢₙ is the shortest pore channel, and L is the straight-line distance in the flow direction, as shown in FIG. 11.

### Fractal Dimensions of Pores

Fractal dimensions are a characteristic parameter of the concrete pore structure. Fractal dimensions are a topological parameter of the complexity of the pore structure, which is believed to be a missing parameter in most studies for modeling the permeability of porous media. A higher fractal dimension means that the pore structure is more complex. In this study, the fractal dimension of the pore structure in the cement materials was calculated using the box-counting method. A square moving window with a side length of aᵢ was used in the 2D pore structure picture with a step size of one pixel. The count number Nᵢ was increased by one if the window contained a pixel of a pore phase. After that, the size of the square window was increased by one and counted to determine Nᵢ₊₁. The process was continued until the box size reached the size of the window of the image. The fractal dimension of the pore structure was determined by fitting the data according to

$${N}_{i} = {ca}_{i}^{- D} \qquad ( 10 )$$

where D is the fractal dimension of the pore structure. Taking the logarithm of Eq. (10), one gets the relationship,

$$log {N}_{i} = - D log ( {ca}_{i} ) \qquad ( 11 )$$

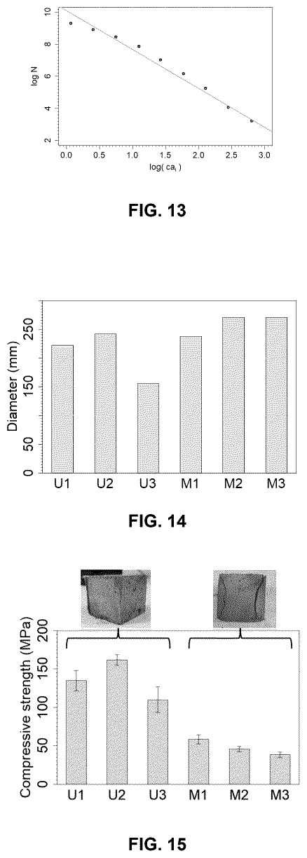

FIG. 13 shows an example of log (Nᵢ) versus log (caᵢ) and the fitted line, which yields D.

### Results and Discussion

### Flowability

FIG. 14 shows the flowability of the traditional mortars and the example articles. The U2 example article had the highest flowability of 248 mm. The flowability of the U3 example article was the lowest among the three example articles. The flowability of example articles was similar but slightly lower than that of mortar mixtures. Without wishing to be bound by any theory, it was assumed that the low flowability of U3 example article is related to the silica fume and silica powder content. U3 example article had a higher content of silica fume and silica powder, which requires more water for the same amount of flowability due to a higher surface area of the dry materials. The rheological behavior of cement slurries is critical in preventing gas-leakage problems in oil well applications because the slurry needs to be mixed on the rig before and then pumped into the well downhole.

### Compressive Strength

FIG. 15 summarizes the compressive strengths of traditional mortars and example articles after 28-day lime water curing. The 28-day static compressive strengths of the example articles were 136 MPa, 162 MPa, and 109 MPa for U1, U2 and U3, respectively. On the other hand, the highest compressive strength of the mortars was 58 MPa for M1, with a w/b ratio of 0.3. U2 example article's compressive strength was 179% higher than that of M1. The mortars showed a 30% decrease in compressive strength when the w/b (or water-to-cement in this case) ratio increased from 0.3 to 0.5. The failure mode during the compression tests was different for the example articles and conventional mortars, as shown in FIG. 15. The failure mode of the mortar samples followed a typical crack pattern resulting from a combination of the compressive and shear stresses caused by the friction at the interface with the loading surfaces. For the example articles, the cracks were more evenly distributed. The mortar samples failed in a very brittle manner after reaching the ultimate load. For the fiber-reinforced example articles, the failure pattern shifted from a brittle pattern to a ductile pattern mainly because of the addition of PVA fibers. Once the peak compressive strength was reached, the stress decreased rapidly, accompanied by a clear failure sound. With the addition of PVA fibers, more cracks developed in the example articles than those in the mortars, and the width of cracks was smaller compared with those in the mortars. Many diagonal cracks showed on the surfaces of specimens, with multiple vertical cracks and some localized failure. Even the completely failed specimens from the example articles maintained good integrity, which could be important for very long-term applications in AOOGW.

### Porosity

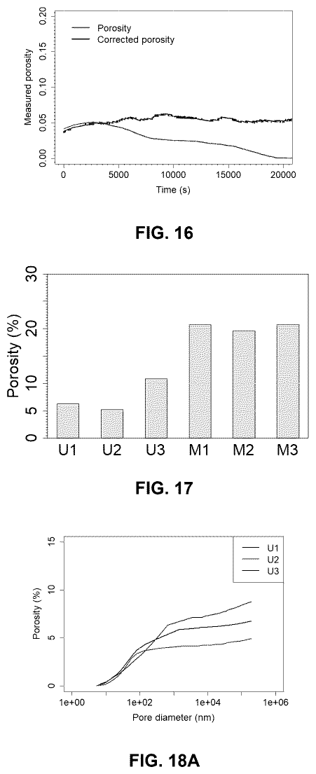

A porosity versus time result is shown in FIG. 16. After the temperature correction, the variation in porosity was less than 7% during the measurement period. The temperature-corrected results for the porosity are given in FIG. 17. The example articles had much smaller pores than the mortars and, hence, a lower porosity. The U2 example article had a slightly lower porosity of 5.5% compared to 6.1% and 10.1% of U1 and U3 articles, respectively.

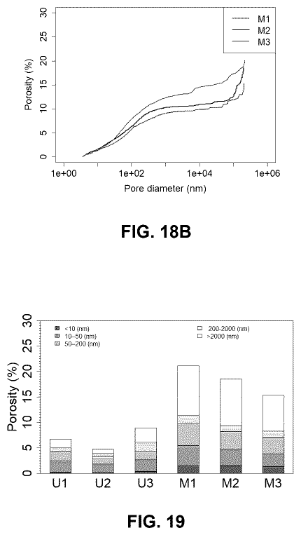

The relationship between the porosity and the pore diameter is shown in FIGS. 18A-18B, while FIG. 19 shows the pore size distribution of the specimens, both of which were obtained from MIP tests. It was found that example articles had smaller pores than mortars as well as a lower overall porosity. The U2 had a slightly lower porosity of 5.1% compared to 7.2% and 8.6% of U1 and U3, respectively. It is also seen that the pores larger than 2,000 nm had the highest percentage of pore volume for the mortar samples among different size ranges. For M1, M2, and M3, the contribution of the pores larger than 2,000 nm to total porosity was 9.2%, 8.8%, and 6.7%, respectively. The same results for U1, U2, U3 were, respectively, 2.9%, 1.1% and 3.8%. The main reasons for this difference are that the example articles were made of very fine materials, the w/b ratio of UHD-CMP was as lower at 0.18, and multiple pozzolanic materials and nanofillers resulted in the formation of additional hydration products in the example articles. The resulting denser microstructure of the example articles compared with the mortars led to a lower porosity. The porosity of the mortars was higher compared to the example articles due to the presence of coarser materials and fewer hydration products to fill the pores. The porosity results obtained from the helium porosimetry testing were higher than those obtained from the MIP for all the samples except for M1 and M2. Without wishing to be bound by any theory, it was assumed that this discrepancy in the porosity measurements included the smaller molecular size of helium, which allowed it to penetrate smaller and finer pores in the samples, and the pressure differences between the two tests might have affected the penetration of helium and mercury differently into the pores (or might have resulted in different levels of microstructural damage creating more pore space).

### Gas Permeability

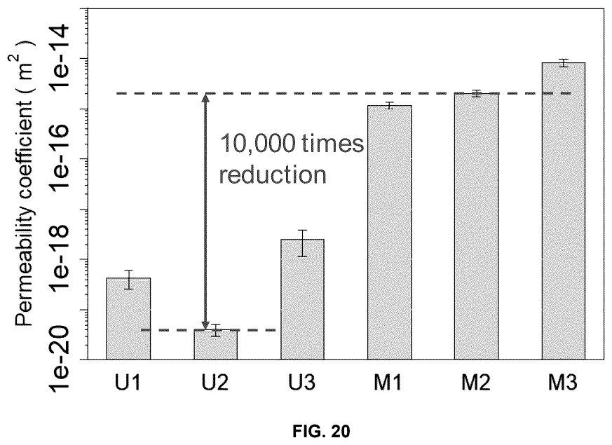

The gas permeability results are shown in FIG. 20. U2 example article showed the lowest gas permeability, followed by U1 and U3 articles. Mortars had a gas permeability within the range from 10⁻¹⁵ to 10⁻¹⁴ m², whereas the example articles had a gas permeability ranging from 10⁻¹⁷ to 10⁻²⁰ m², which indicates up to five orders of magnitude improvement in performance. Among the three mortar mixes, M1 showed the lowest gas permeability.

Unlike water permeability, gas permeability is more difficult to quantify because the gas permeability is affected by the applied pressure and the saturation of the sample. In addition, there are only a few studies that have measured the gas permeability of cementitious materials. Flow rate measurements in steady-state are most commonly used. The gas permeability of cement mortars with w/b ratios ranging from 0.4 to 0.6 was previously investigated. The gas permeability was found to be in the range of 10⁻¹⁷ to 10⁻¹⁸ m². For cementitious materials with lower w/b ratios, the gas permeability, using a steady-state setup with flow rate measurements, was reported to be around 10⁻¹⁸ m². Other studies have also reported similar gas permeability results. However, in all these studies, the flow of the gas was measured by a flowmeter, which is not preferred due to the very low permeability of the material. In this study, the actual pressure rather than the flow rate was measured by a highly sensitive pressure gauge, which is a more suitable and indirect measure of the slow gas flow. Additionally, the measurement of the gas permeability under a vacuum is different than the measurement under pressures higher than the atmospheric pressure. Without wishing to be bound by any theory, it was found that the gas permeability under a vacuum is higher than that under the atmospheric pressure due to the lower mean pressure (the average pressure upstream and downstream) in the vacuum conditions. In this study, a very high vacuum environment is created in the downstream chamber; thus, the obtained gas permeability can be higher than those measured at higher pressures. The results presented here in terms of mortar versus example articles should be evaluated comparatively and not directly with the results in other studies due to the differences explained above. For comparison purposes, the same testing methods and parameters should be followed. It is also noted that these examples measured the apparent permeability rather than the intrinsic air permeability, which is difficult to measure. Apparent permeability depends on measuring pressure, while intrinsic air permeability describes the air permeability of porous media when there is no pressure difference between the upstream and downstream chambers. The intrinsic air permeability is typically determined by extrapolating a plot of apparent air permeability versus the inverse of the mean pressure according to the Klinkenberg effect. However, when gas permeability is measured under vacuum pressure, it can lead to a negative intrinsic permeability, which makes measuring the intrinsic permeability hard with Klinkenberg's approach.

### Pore Characteristics Based on CT-Scan Data

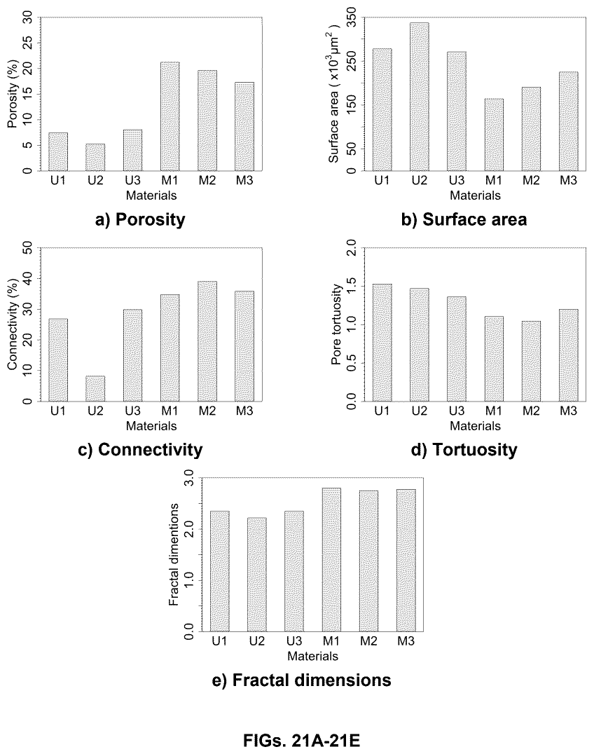

The results from the analysis of the pore structure from micro-CT scan data are shown in FIGS. 21A-21E. In FIG. 21A, it is seen that the porosity follows the same pattern as the results obtained from helium porosimetry and MIP. The accuracy of the porosity measured from the image-based method relies on the precision of pore identification. Compared to the other two methods, the porosity measurements using the micro-CT scan data had an inherent limitation in capturing pores smaller than the image resolution. Pores smaller than the resolution of the micro-CT scan decrease the gray level of the voxel. Higher pore volume in the voxel results in a lower gray level. Because it is not possible to identify the pores with a size less than the size of a voxel, the pore segmentation in a micro-CT scan image has an influence on the porosity and pore structure calculations. The calibration method, as mentioned above, has mostly alleviated the error from this resolution issue. The image-based method is investigated here because it can determine the actual porosity more closely and includes all the pores within the material, while helium porosimetry and MIP can only measure the pores accessible to the intrusion media. In this study, it was found that the porosity obtained by the CT scan is comparable with the other two methods after calibration.

It is seen in FIG. 21B that U2 example article has a higher surface area compared to U1 and U3, while it has less porosity. Among the mortars, M3 has more surface area compared to M1 and M2. As seen in FIGS. 21C, the connectivity of pores in U2 is less than 30% of that in the other five samples, which all have a connectivity larger than 25%. The dramatically less connectivity in the U2 sample may be a reason for its lower permeability compared to U1 and U3, while the porosities of the three materials do not show a large difference. As seen in FIG. 21D, the tortuosity of the mortar samples is close to one, while that of the example articles is around 1.5. Tortuosity is one of the critical parameters in the semi-empirical Kozeny-Carman equation for predicting the permeability of the pore structure. These results indicate the difference between the pore structure of the example articles and the mortar samples. The mechanical and transport properties of concrete are directly influenced by the spatial network of the pore phase. The fractal dimensions are shown in FIG. 21E, the example articles had an average value of 2.3, while the same for the mortar samples was 2.7. Compared with traditional methods to test the pore system inside concrete, it was demonstrated that the micro-CT scan data can characterize the internal pore structure of cementitious materials in multiple facets.

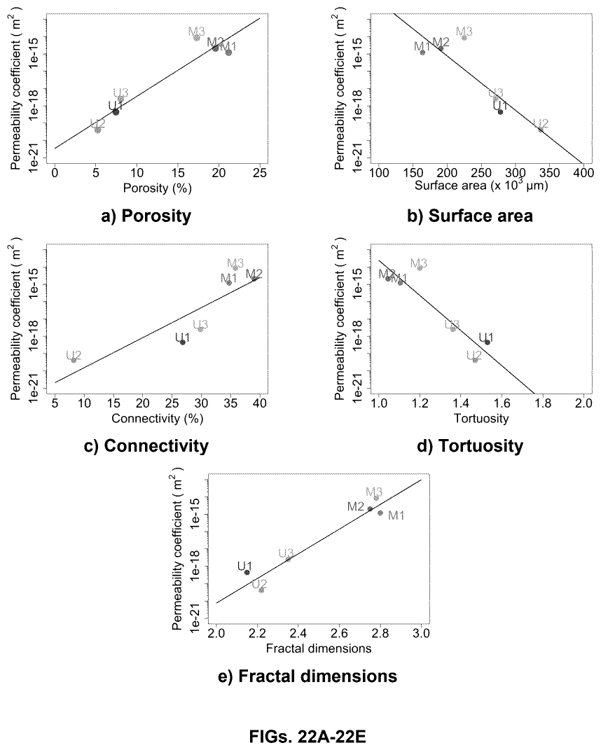

FIGS. 22A-22E illustrate the relationships between the six pore structure parameters and the measured gas permeability. As shown in FIGS. 21A-21E, the properties of the mortar and example articles are very different, as the dots for the three mortars are far from the dots for the example articles. When plotted against the log of permeability coefficient, a linear relationship is obtained between the permeability coefficient and the porosity, surface area, connectivity, tortuosity, and fractal dimensions. The R² values for the semi-log linear fitting were respectively obtained as 0.86, 0.75, 0.68, 0.78, and 0.91 for these parameters. The porosity and fractal dimensions display a well-fitted linear relationship. The coefficient of the fitting for permeability coefficient versus porosity was found as 0.6909 m⁻², and the same for fractal dimensions versus permeability coefficient was found as 16.37 m⁻².

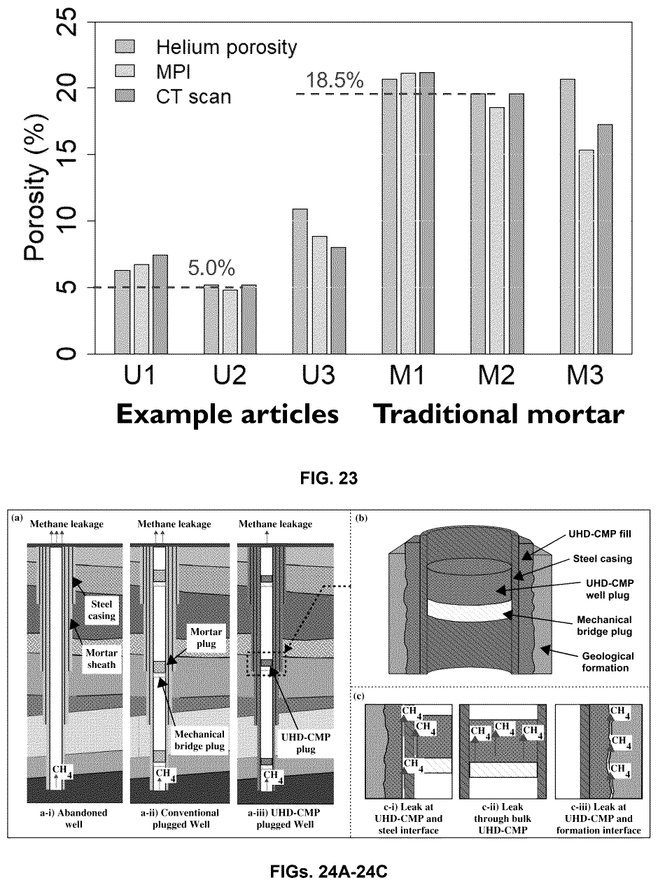

FIG. 23 shows a comparison of porosity measured by various techniques described herein.

### Conclusions

This example article was developed to be used in the P & A operations of AOOGW. A comparative assessment was performed, investigating various properties, including compressive strength, flowability, porosity, gas permeability, and pore structure, between the formulated example articles and standard cement mortar mixtures with w/b ratios spanning from 0.3 to 0.5. The principal conclusions drawn from this study are as follows.

The porosity of the example articles was less than 25% of the porosity of the mortars, which was confirmed by three porosity measurement techniques: helium porosimetry, MIP, and micro-CT scans.

The distribution of the pore size in the example article and mortar samples was also different. In the three mortar mixtures, pores with diameters larger than 2000 nm took up more than 8% of the total pore volume, while the same value in the example articles samples was less than 3%.

A linear relationship between porosity, surface area, connectivity, fractal dimensions, and permeability was found using the micro-CT scan data. Although the physical effect of fractal dimensions on permeability is not clear, it was found to have the strongest correlation with the experimental permeability.

### Example 2

Methane leakage from abandoned oil and gas wells contributes to greenhouse gas emissions and groundwater contamination. Compromised sealing at the cement-steel and cement-formation interfaces act as primary pathways for methane leakage. Although traditional cement mortars are commonly used for well plugging, they exhibit high shrinkage, limited tensile strength, and insufficient interface bonding under downhole conditions. Prior studies have primarily emphasized shear bond strength and bulk mechanical properties of traditional cement mortars using push-out tests, slant-shear tests, and friction-sliding tests, while the effects of normal (tensile) bonding and gas permeability at interfaces remain less well understood. This study further develops and evaluates an ultra high-durability cement mortar plug (UHD-CMP), previously formulated by the inventors to address these specific limitations. A series of experiments was conducted to measure compressive strength, shrinkage, porosity, gas permeability, and interface bond strength (both shear and normal) at the cement-steel and cement-sandstone interfaces. Tests were performed under five curing conditions representing downhole thermal and moisture exposures. The study also evaluated three shrinkage-reducing admixtures: magnesium oxide (MgO), a calcium oxide (CaO)-based expansive agent, and a surfactant (SRA)-based reducer. UHD-CMP achieved compressive strengths up to 162 MPa and porosity values as low as 4.8%. Gas permeability in both bulk and interface regions was reduced by up to four orders of magnitude compared to conventional mortars. Higher interfacial bond strengths were observed at both steel and sandstone interfaces, particularly under drying and thermal curing when UHD-CMP was modified with MgO. These results indicate that UHD-CMP formulations can improve sealing performance in well abandonment applications by reducing permeability and increasing bond durability under variable downhole conditions.

### INTRODUCTION

Wellbores serve critical roles in the extraction of fossil fuels, harnessing geothermal energy, and carbon dioxide sequestration. Once these wells reach the end of their operational life, they must be securely plugged and abandoned to prevent the migration of hydrocarbons, formation fluids, and greenhouse gases. This process is essential for maintaining zonal isolation and limiting environmental risks such as methane release and groundwater contamination. Ordinary Portland cement (OPC)-based mortars are the industry standard for this purpose; however, they exhibit limitations including autogenous shrinkage, cracking under thermal and mechanical stress, low tensile strength, and chemical degradation in the presence of carbon dioxide and hydrogen sulfide. These deficiencies increase gas permeability and enable leakage pathways, particularly along interfaces between the cement, steel casing, and surrounding formation. Inadequate cement placement or long-term degradation can elevate permeability from the intact range of 10⁻¹⁸ to 10⁻¹⁴ m² up to values near 10⁻¹² m², increasing the risk of gas migration. In the United States, approximately 120,000 abandoned wells are estimated to emit 294 kilotons of methane annually, and in the Gulf of Mexico, failed cement plugs account for nearly one-third of documented well integrity failures.

Efforts to improve plug performance have focused on enhancing mechanical strength, densifying the microstructure, and reducing bulk permeability. However, the quality of bonding at the interfaces between the cementitious material, steel casing, and surrounding geological formation plays a significant role in the overall plug performance. Zonal isolation depends not only on the material's intrinsic properties but also on the adhesion at these interfaces, which helps prevent debonding and leakage. Interfacial bonding is typically evaluated by measuring shear bond strength through standardized methods such as push-out tests, slant-shear tests, and friction-sliding tests. Push-out tests apply axial loads to cement placed inside steel tubes to quantify shear resistance, while slant-shear tests assess the shear response of angled cement-steel interfaces under compressive loading. Friction-sliding methods characterize interfacial friction but may not account for progressive bond degradation or its influence on the gas transport. Although these shear-dominant methods provide comparative metrics, they do not fully capture the interaction between shear and normal stresses that can influence interface performance under downhole stress conditions.

In particular, the role of normal bonding has received limited experimental attention, despite evidence that it plays a significant role in interfacial debonding. Previously, triaxial direct shear tests were conducted to evaluate both shear strength and hydraulic permeability at cement-steel interfaces, demonstrating that interfacial strength was primarily governed by friction, with minimal cohesive contribution. Their results indicated that variations in normal stress had a measurable impact on the interface behavior. Other researchers used a 3D cohesive zone model to simulate debonding at the cement plug-casing interface, considering fluid migration and interfacial stresses. Their results showed that increasing normal bond strength from 1 MPa to 4 MPa reduced fracture height from 2.8 m to 0.1 m, a greater effect than similar improvements in shear strength. These findings suggest that normal bonding can greatly influence sealing behavior. However, there remains a lack of experimental evidence that isolate and quantify normal bond strength, pointing to an area in need of further investigation.

In addition to interfacial behavior, the permeability of the cement matrix itself plays a central role in plug effectiveness. The water-to-binder (w/b) ratio governs microstructural density and fluid transport properties, with lower w/b ratios typically reducing porosity and permeability. Ultra high-performance concrete (UHPC), defined by its low w/b ratio, high binder content, and dense particle matrix, has demonstrated exceptional resistance to gas and fluid transport. An intrinsic gas permeability as low as 1.2×10⁻¹⁸ m² for UHPC was reported with a w/b ratio of 0.22 at ambient conditions, with minimal increases observed up to 300° C. Previously it was found that UHPC maintains its air permeability near 10⁻¹⁸ m² under vacuum, which is more than two orders of magnitude lower than that of the conventional cement systems. Values between 1.32×10⁻¹⁹ and 0.11×10⁻¹⁹ m² after 90 days of curing, with even lower permeability observed for UHPC modified with nanomaterials were reported. These low permeability values were attributed to UHPC's dense pore structure and minimal capillary connectivity, which limit gas migration and enhance long-term durability. While such characteristics make UHPC a promising candidate for well sealing applications, its use in oil and gas well abandonment remains limited and requires further evaluation under representative subsurface conditions.

To address these gaps, the authors previously developed an ultra high-durability cement mortar plug (UHD-CMP). Inspired by the design principles of UHPC, UHD-CMP incorporates a low w/b ratio combined with a high-range water reducer (HRWR), along with densified silica fume, silica powder, and polyvinyl alcohol (PVA) fibers, to achieve ultra-low gas permeability, enhanced compressive and tensile strength, improved dimensional stability, and increased resistance to chemical degradation. Prior testing showed that UHD-CMP reduced porosity by approximately 75% and achieved gas permeability as low as 10⁻²⁰ m², several orders of magnitude lower than conventional mortars. These results, without being bound by any theory, were associated with a refined pore structure and improved particle packing. However, high autogenous shrinkage was also observed, which may affect interface bonding and long-term sealing performance. This necessitates targeted strategies to mitigate shrinkage while maintaining the dense microstructural and low permeability characteristics of UHD-CMP.

This study builds on previous work by evaluating the sealing performance of UHD-CMP under simulated downhole conditions. Specifically, three potential methane migration pathways were examined: through the cement-steel interface, the bulk cement matrix, and the cement-formation interface. These pathways are illustrated in FIGS. 24A-24C, which compares abandoned, conventionally plugged, and UHD-CMP-plugged wells. To simulate subsurface environments, specimens were cured under five controlled thermal and humidity regimes. To reduce shrinkage, three admixtures were investigated: magnesium oxide (MgO), a calcium oxide (CaO)-based expansive agent, and a surfactant (SRA)-based shrinkage reducer. The experimental program included compressive strength and shrinkage tests, helium and mercury porosimetry, gas permeability measurements, and interface bond strength evaluations through push-out and pull-off tests. These experimental results provide a comprehensive evaluation of UHD-CMP's well sealing performance and offer insights into its potential application for well abandonment, with implications for reducing methane leakage and improving long-term environmental containment.

### Materials

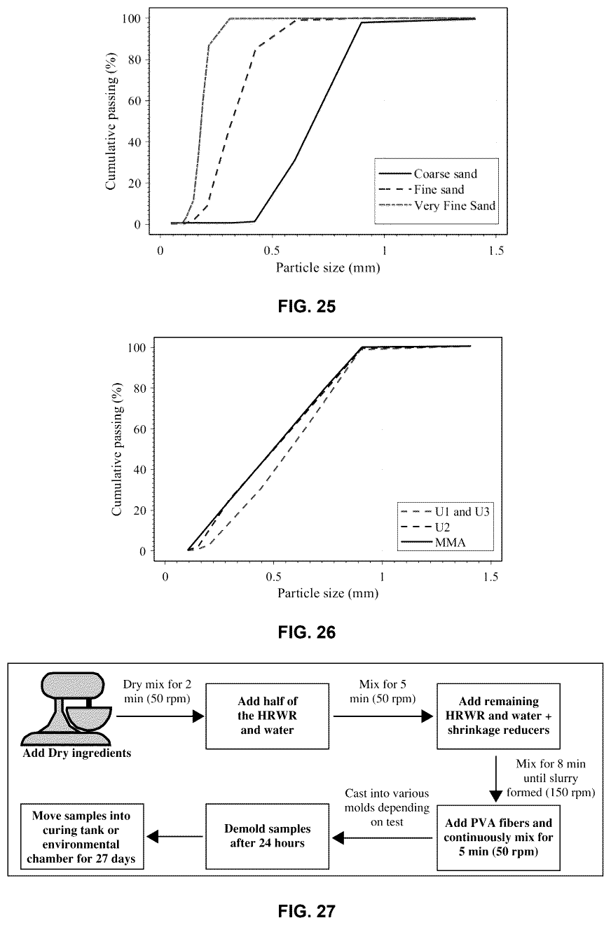

Conventional mortar samples were prepared using ASTM C150 Type I/II OPC and coarse sand with a maximum particle size of 1.19 mm. For the UHD-CMP mixtures, the same Type I/II OPC and coarse sand were combined with two additional silica sand types: fine sand and very fine sand, with maximum particle sizes of 600 μm and 212 μm, respectively. The specific gravities of the coarse, fine, and very fine sands were 2.65, 2.63, and 2.65, respectively. Their particle size distributions are shown in FIG. 25. Additional constituents in the UHD-CMP mixtures included densified silica fume (>95% SiO₂, Norchem), silica powder (SIL-CO-SIL, U.S. Silica), a polycarboxylate-based HRWR (ViscoCrete-2110, SIKA USA), and PVA fibers (RECS15, Nycon). The silica fume, compliant with ASTM C1240, had a median particle size of 0.114 μm, while the silica powder had a specific gravity of 2.65 and a mean particle size of 5 μm. The PVA fibers had a length of 8.0±1.0 mm, a diameter of 38 μm, a specific gravity of 1.3, and a tensile strength of 1,600 MPa. Three chemical admixtures were incorporated individually to reduce autogenous shrinkage: MgO, a CaO-based expansive agent (MasterLife CRA 007), or an SRA-based shrinkage reducer (MasterLife SRA 035), all provided by Master Builders Solutions. Sandstone was used as the substrate material for interfacial bonding tests to represent typical geological formations. The sandstone had a porosity of 18-21% and a gas permeability ranging from 2.2 m² to 2.5×10⁻¹³ m².

### Mix Proportions

For baseline comparison to UHD-CMP mixtures, Table 3 presents three conventional mortar mixtures (M1, M2, and M3) prepared with w/b ratios of 0.3, 0.4, and 0.5, respectively, and a fixed coarse sand-to-cement ratio of 1.0. Table 4 shows that the UHD-CMP mixtures adopted a lower w/b ratio of 0.18 to enhance durability and reduce permeability. HRWR was added at 6% by weight of cementitious materials to achieve optimal flowability, and PVA fibers were incorporated at a volume fraction of 0.5%. Silica fume and silica powder content varied among the UHD-CMP mixtures, with their respective proportions being: 32.4% in U1 and U2, and 37.4% in U3. Aggregate proportions for UHD-CMP mixtures were selected using the Modified Andreasen and Andersen (MMA) particle packing theory, aiming for maximum particle density and improved mechanical properties as was previously described. The percentage, P(d), of a given particle diameter, d, is given by

$$P ( d ) = \frac{d - {d}_{min}}{{d}_{max} - {d}_{min}} \qquad ( 1 )$$

where dₘₐₓ and dₘᵢₙ are respectively the maximum and minimum particle sizes in the aggregate. FIG. 26 illustrates that U2, which contains very fine sand, closely matched the MMA target distribution compared to U1 and U3. Previous studies confirmed the effectiveness of the MMA model in guiding UHPC mixture design to improve density and mechanical properties.

TABLE 3
Mixture proportions for conventional mortars M1, M2, and M3.

| | Amount (kg/m³) | | |
|---|---|---|---|
| Ingredient | M1 | M2 | M3 |
| Cement | 1034.9 | 1034.9 | 1034.9 |
| Coarse Sand | 989.92 | 989.92 | 989.92 |
| Water | 310.46 | 413.95 | 517.44 |

TABLE 4
Mixture proportions for UHD-CMP U1, U2, and U3.

| | Amount (kg/m³) | | |
|---|---|---|---|
| Ingredient | U1 | U2 | U3 |
| Cement | 899.43 | 899.43 | 808.93 |
| Silica fume | 215.67 | 172.53 | 242.53 |
| Silica powder | 215.67 | 258.80 | 242.53 |
| Fine sand | 287.55 | 301.93 | 287.55 |
| Very fine sand | 0 | 86.27 | 0 |
| Coarse sand | 575.11 | 474.46 | 575.11 |
| Water | 245.28 | 245.28 | 245.28 |
| HRWR¹ | 60.03 | 60.03 | 60.03 |
| PVA fiber² | 5.45 | 5.45 | 5.45 |

¹HRWR.
²PVA.

### Shrinkage Mitigation

Shrinkage mitigation strategies were evaluated using the U2 mixture, which exhibited the closest alignment with the MMA particle packing model. As summarized in Table 5, three admixtures were tested at varying dosages to assess their influence on autogenous shrinkage: MgO, CaO-based expansive agent, and an SRA-based agent. MgO was included for its hydration-induced expansion behavior, which can offset early-age volume contraction. The CaO-based expansive agent was selected based on its ability to produce controlled expansion during hydration, thereby limiting shrinkage-induced tensile stress development. The SRA-based shrinkage reducer was incorporated to investigate its role in reducing capillary stress and stabilizing internal pore structure during early hydration. These admixtures were selected based on prior studies reporting reductions in autogenous shrinkage and improved volume stability in UHPC systems.

TABLE 5
Shrinkage-reducing admixtures
and dosages used in UHD-CMP U2.

| Label | Shrinkage agent | Dose |
|---|---|---|
| U2-MGO1 | MgO-based expansive agent | 2% by wt. of cement |
| U2-MGO2 | | 4.5% by wt. of cement |
| U2-MGO3 | | 7% by wt. of cement |
| U2-SRA1 | SRA-based shrinkage reducer | 2.5 L/m³ |
| U2-SRA 2 | | 5 L/m³ |
| U2-SRA 3 | | 7.5 L/m³ |
| U2-CRA1 | CaO-based expansive agent | 5 L/m³ |
| U2-CRA 2 | | 7.5 L/m³ |
| U2-CRA 3 | | 10 L/m³ |

### Mixing Procedures

The mixing procedure was refined over several iterations for UHD-CMP preparation. The final procedure found to be effective is shown in FIG. 27. All dry materials were first combined in a mortar mixer and mixed at 50 rpm for 2 minutes. Then, 50% of the total water and HRWR were gradually added and mixed at 50 rpm for an additional 5 minutes. The remaining water and HRWR were subsequently introduced, and the mixing speed was increased to 150 rpm, and the mixing was continued for another 8 minutes. Finally, PVA fibers were added gradually and mixed at 50 rpm for 5 minutes. The initial simultaneous addition of dry components was intended to promote particle contact with the mixer wall and increase shear between particles, which can improve wetting efficiency and early-stage dispersion of water and HRWR. Conventional mortar mixtures followed a simplified mixing protocol: powder materials were dry-mixed at 50 rpm for 3 minutes, followed by gradual addition of water and continued mixing at 50 rpm for 6 minutes. A final high-speed mixing stage was carried out at 150 rpm for 1 minute.

### Casting and Curing

As shown in FIG. 27, after mixing, samples were cast into molds corresponding to the requirements of each mechanical, permeability, and bonding test. Initial curing was conducted in a controlled environment at 23±2° C. and 50±5% relative humidity for 24 hours prior to demolding. To evaluate the influence of environmental conditions relevant to wells, five distinct curing regimes were tested, as summarized in Table 6. Regime C1 involved saturated lime water curing at 23±2° C. C2 used an environmental chamber (ZPHS-64-2-H/AC, CSZ Cincinnati Sub-Zero) with set temperature and humidity levels. C3 employed a cyclic curing protocol, alternating daily between saturated lime water and 70% relative humidity at 23±2° C., to simulate variable moisture exposure. C4 and C5 consisted of dry curing in temperature-controlled ovens (WTC/A160 Cyclic Corrosion Test Chamber, WT Weice) without humidity regulation, intended to represent dry or elevated-temperature conditions encountered in some subsurface environments.

TABLE 6
Curing conditions for samples prior to testing.

| Curing | | | Duration |
|---|---|---|---|
| condition | Humidity (%) | Temperature (° C.) | (days) |
| C1 | 100% | 23 | 27 |
| C2 | 70% | 23 | 27 |
| C3 | 100% and 70% | 23 | 27 |
| C4 | N.A. | 50 | 27 |
| C5 | N.A. | 90 | 27 |

### EXPERIMENTAL METHODS

### Test Matrix

As summarized in Table 7, eight tests were conducted to evaluate the performance of UHD-CMP in terms of physical properties (drying shrinkage, porosity and gas permeability) and mechanical properties (compressive strength and interfacial bonding performance). Drying shrinkage testing was used to quantify volumetric changes during curing, which can influence bond performance over time. Porosity and permeability properties were assessed through helium porosimetry for total porosity, mercury intrusion porosimetry for pore size distribution, and gas permeability testing for permeability coefficients of both bulk material and cement-interface systems. Compressive strength testing established a reference for mechanical behavior, and it was used as an indirect indicator of microstructural density. Interfacial bonding was evaluated through push-out tests for shear resistance and pull-off adhesion tests for normal bond strength at cement-steel and cement-sandstone interfaces. The inclusion of normal bond strength testing aimed to address the limited experimental data available on tensile interface performance in cementitious sealing systems.

TABLE 7
Summary of specimen types and dimensions, number of samples,
curing conditions, and referenced standards for each test.

| | Specimen | | | | Testing |
|---|---|---|---|---|---|
| | Type and | | Number | Curing | Standard/ |
| Property | Dimensions | Sample Groups* | of Tests | Conditions | Reference |
| Drying | 25 × 25 × | M1, M2, M3, U1, | 15 | C1 | ASTM C157 |
| Shrinkage | 275 mm | U2, U3, U2- | samples | | |
| | prism | MG01, U2-MG02, | | | |
| | | U2-MG03, U2- | | | |
| | | SRA1, U2-SRA2, | | | |
| | | U2-SRA3, U2- | | | |
| | | CRA1, U2-CRA2, | | | |
| | | U2-CRA3 | | | |
| Porosity | 50 mm | Same as above + | 35 | C1, C2, | Custom |
| based on | cube | M3, U2, U2- | samples | C3, C4, | Method |
| Helium | | MG01, U2-SRA3, | | C5 | |
| Porosimetry | | U2-CRA1 (C2-C5) | | | |
| Porosity | 10 mm | M3, U2 (C1) + | 11 | C1, C2, | Washburn's |
| based on | cube | U2-MG01, U2- | samples | C5 | Eq |
| Mercury | | SRA3, U2-CRA1 | | | |
| Intrusion | | (C1, C2, C5) | | | |
| Porosimetry | | | | | |
| Gas | Cylinder, 70 | Same as helium | 35 | C1, C2, | Custom |
| Permeability | mm dia. × | porosimetry | samples | C3, C4, | Method |
| (Mortar or | 50 mm | | | C5 | |
| UHD-CMP) | height | | | | |
| Gas | Cylinder, 70 | M1, M2, M3, U1, | 14 | C1, C2 | Custom |
| Permeability | mm dia. × | U2, U3 (C1) + | samples | | Method |
| (Mortar or | 50 mm | M3, U2, U2- | | | |
| UHD-CMP- | height | MG01, U2-SRA1, | | | |
| Steel- | | U2-CRA1 (C1-C2) | | | |
| Interface) | | | | | |
| Compressive | 50 mm | M1, M2, M3, U1, | 15 | C1 | ASTM C109 |
| Strength | cube | U2, U3, U2- | samples | | |
| | | MG01, U2-MG02, | | | |
| | | U2-MG03, U2- | | | |
| | | SRA1, U2-SRA2, | | | |
| | | U2-SRA3, U2- | | | |
| | | CRA1, U2-CRA2, | | | |
| | | U2-CRA3 | | | |
| Shear Bond | Cylinder | M1, M2, M3, U1, | 75 | C1, C2, | Custom |
| Strength | cast in | U2, U3, U2- | Samples | C3, C4, | Method |
| (Push-Out | steel, 38 | MG01, U2-MG02, | | C5 | |
| Test) | mm dia. × | U2-MG03, U2- | | | |
| | 50 mm | SRA1, U2-SRA2, | | | |
| | height | U2-SRA3, U2- | | | |
| | | CRA1, U2-CRA2, | | | |
| | | U2-CRA3 | | | |
| Normal Bond | Cylinder, 50 | M1, M2, M3, U2, | 35 | C1, C2, | ASTM |
| Strength | mm | U2-MG01, U2- | Samples | C3, C4, | D7522 |
| (Pull-Off | diameter | SRA3, U2-CRA1 | | C5 | |
| Test) | | | | | |

*Sample group labels (e.g., M1-M3, U1-U3, U2-MG01, U2-SRA3, U2-CRA1, etc.) follow the naming conventions and definitions provided in Table 3 (conventional mortars), Table 4 (UHD-CMP mixtures), Table 5 (shrinkage-reducing admixtures used in U2), and Table 6 (curing conditions for samples).

### Physical Properties

### Drying Shrinkage

Drying shrinkage was evaluated using prismatic specimens measuring 25×25×275 mm, following ASTM C157. Metal inserts were embedded at both ends of each mold before casting to serve as fixed reference points for length measurements. At 24 hours after casting, the initial length of each specimen was recorded using a length comparator. Following the initial measurement, specimens were placed in the C1 curing condition. To monitor shrinkage, samples were removed from the curing environment at predefined intervals for length measurement. Shrinkage was measured at 3, 7, 14, 21, 28, 56, and 90 days. The shrinkage strain in percent, Lₓ, at each age was calculated using

$${L}_{x} = \frac{( {L}_{i} - {L}_{f} )}{G} \times 100 \qquad ( 1 )$$

where Lᵢ is the initial comparator reading of the specimen minus the comparator reading of the reference bar, L_{f} is the comparator reading of the specimen at age x minus the comparator reading of the reference bar at age x, and G is the nominal gauge length (i.e., 250 mm). Shrinkage strain values were converted to microstrain (με), and the average of three specimens was reported for each mixture.

### Porosity Based on Helium Porosimetry

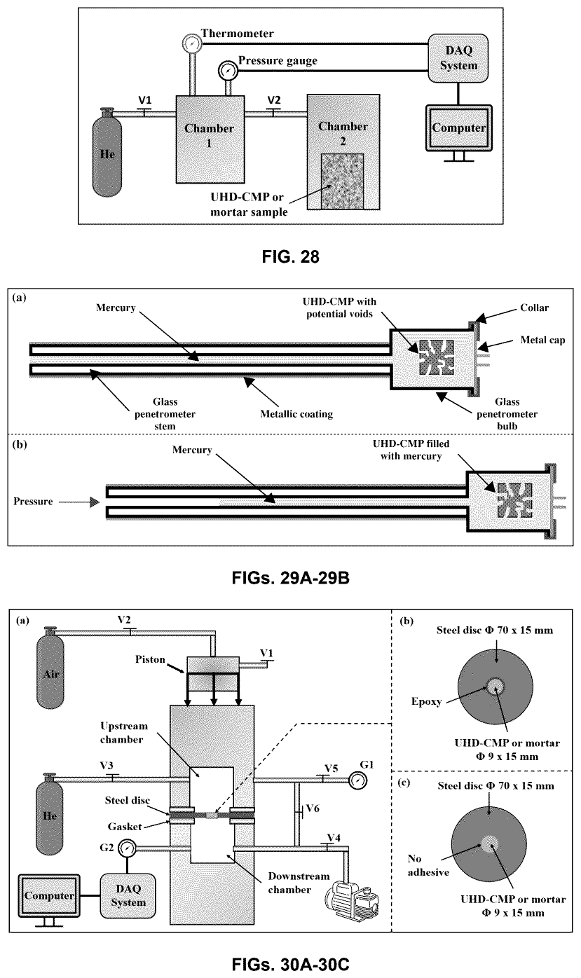

Porosity of UHD-CMP and conventional mortar was evaluated using 50 mm cube specimens and a custom-built helium porosimeter shown in FIG. 28. The apparatus consists of two chambers: an expansion chamber (Chamber 1) and a sample chamber (Chamber 2), designed to operate based on Boyle's Law, which describes the relationship between pressure and volume in a closed system at constant temperature according to

$${P}_{1} {V}_{1} = {P}_{2} {V}_{2} \qquad ( 2 )$$

where P₁ and V₁ are the initial pressure and volume of Chamber 1, and P₂ and V₂ are the final pressure and expanded volume after helium enters Chamber 2.

The test began by placing the specimen in Chamber 2 and introducing helium into Chamber 1 by opening valve 1 (V1). After pressure stabilization in Chamber 1, V2 was opened, allowing helium to expand into Chamber 2 and permeate into the specimen's pore structure. The pressure drop resulting from helium infiltration was continuously monitored using a 1000-Torr manometer (1000TKF16, Kurt J. Lesker Company) and recorded via a data acquisition system. The total volume, V₂, after expansion was calculated as

$${V}_{2} = {V}_{1} + {V}_{c 2} - {V}_{b} + {V}_{p} \qquad ( 3 )$$

where V_{c2} is the volume of Chamber 2, Vₚ is the bulk volume of the sample, and Vₚ is the pore volume to be determined. The solid volume of the sample, Vₛ, is determined as

$${V}_{s} = {V}_{2} ( \frac{{P}_{1} {T}_{2}}{{T}_{1} {P}_{2}} + 1 ) {V}_{1} \qquad ( 4 )$$

where T₁ and T₂ are the temperatures recorded at initial and final pressure states, respectively, and the remaining variables have been defined previously. Since helium pressure is sensitive to temperature changes, tests were repeated at five different temperatures ranging from 18° C. to 30° C. to improve accuracy and minimize thermal fluctuations. Finally, the porosity, φ, of the sample is calculated as

$$φ = \frac{V - {V}_{s}}{V} \qquad ( 5 )$$

where V is the bulk volume of the sample obtained using the water displacement method, and the other variables defined previously. By averaging the results across five temperature conditions, porosity values were obtained for each sample.

### Porosity Based on Mercury Intrusion Porosimetry

The pore size distribution of UHD-CMP was characterized using mercury intrusion porosimetry (MIP), a technique used to evaluate the internal pore structure of solid materials. MIP operates on the principle that mercury, as a non-wetting liquid, requires external pressure to intrude into the pores. The applied pressure is inversely related to the pore radius, r, as described by Washburn's equation according to

$$r = - \frac{2 γ cos θ}{P} \qquad ( 6 )$$

where P is the applied pressure, γ is the surface tension of mercury (480 mN/m), and θ is the contact angle between mercury and the pore surface, which is taken as 140° based on previously reported results. Testing was performed using an AutoPore IV 9500 porosimeter, which applies pressures up to 414 MPa and measures pore diameters ranging from approximately 3 nm to 360 μm. Specimens were 10 mm cubes and oven-dried at 60° C. for 24 hours to reduce moisture content prior to testing. The measurement procedure is illustrated in FIGS. 29A-29B. As shown in FIG. 29A, the dried sample was placed into a glass penetrometer, consisting of a cylindrical bulb and a narrow metallic-coated stem for pressure monitoring. After sealing the penetrometer with a metal cap, the chamber was evacuated to below 50 microns of mercury and then filled with mercury. Mercury initially filled the bulb and stem, surrounding the sample. As pressure was incrementally applied, mercury was progressively forced into the material's pore structure, first entering larger pores and then smaller ones, as illustrated in FIG. 29B. The volume of mercury intruded at each pressure level was recorded to determine the corresponding pore size distribution.

### Gas Permeability

Gas permeability was measured using a custom-built steady-state permeability tester to evaluate the transport characteristics of mortar, UHD-CMP, and their interfaces with steel, as shown in FIGS. 30A-30C. Two sets of specimens were prepared to distinguish between intrinsic material permeability and interface effects. In one set, the interface between the cementitious material and steel was sealed with epoxy to isolate bulk permeability. In the other set, the interface was left unsealed to allow gas to flow through potential interfacial pathways, thereby capturing the combined effect of the bulk material and the interface. Each sample was cast into a steel disc (70 mm diameter, 15 mm thick) with a central cylindrical hole (9 mm diameter×15 mm depth) filled with either mortar or UHD-CMP. The sealed configuration involved applying epoxy around the interface, while the unsealed configuration was left as-cast.

During testing, samples were placed in the gas permeability setup, which consisted of separated upstream and downstream chambers. A piston compressed the sample from above to ensure a tight seal. Initially, V1 was closed and V2 opened to pressurize the piston chamber with air at 0.69 MPa. V4, V5, and V6 were opened while V3 remained closed to evacuate both chambers to a vacuum of 40 mtorr using a vacuum pump. After vacuuming, V4 and V6 were closed and V3 was opened to introduce helium gas into the upstream chamber, reaching a pressure of approximately 0.31 MPa. The downstream pressure was monitored continuously using a manometer (1000TKF16, Kurt J. Lesker Company) and logged with a DAQ system. Once testing was completed, V2 was closed and V1 opened to release pressure and allow for specimen replacement. The rate of gas accumulation in the downstream chamber, dv/dt was calculated using

$$\frac{dv}{dt} = \frac{273 * {V}_{d} * ( \frac{dp}{dt} )}{101 , 325 * T} \qquad ( 7 )$$

where V_{d} is the volume of the downstream chamber, dp/dt is the rate of pressure increase, and T is the ambient temperature in Kelvin. Then, the gas permeability coefficient, Kᵥ, which quantifies how easily gas flows through a porous material, was calculated using

$${K}_{v} = \frac{\frac{dV}{dt} * h * μ}{10 , 000 * A * Δ P} \qquad ( 8 )$$

where h is the sample thickness,μ is the dynamic viscosity of helium, A is the cross-sectional area of the sample, and ΔP is the pressure differential between the upstream and downstream chambers (held constant at approximately 0.31 MPa). Since the change in downstream pressure is minimal (less than 0.2% of upstream pressure), ΔP was considered constant throughout the test.

### Mechanical Properties

### Compressive Strength

Compressive strength was determined using 50 mm cube specimens according to ASTM C109. After 24 hours of initial curing, the specimens were demolded and placed into curing condition C1 for 27 days to establish a baseline compressive strength for each material. At the testing age, compressive strength was measured using a static hydraulic system (SATEC 5592-F2 U™), applying a constant loading rate of 0.25 MPa/s until specimen failure. The peak load was recorded, and compressive strength was calculated as the maximum load divided by the cross-sectional area. The average strength from three specimens was reported for each material.

### Shear Bond Strength

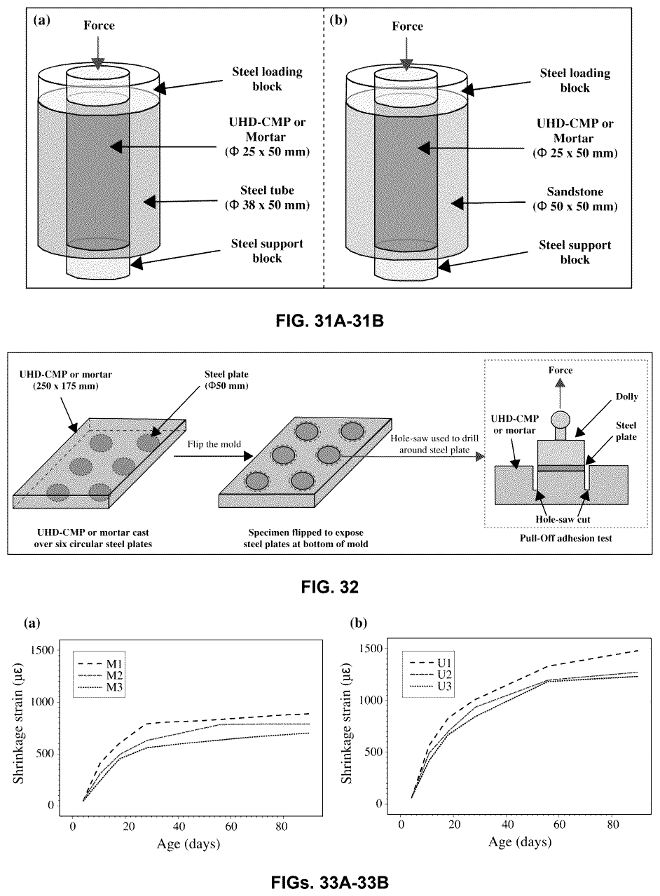

Shear bond strength between the cementitious materials and steel or sandstone was evaluated using a custom-designed push-out test setup, as shown in FIGS. 31A-31B. In this method, UHD-CMP or mortar were cast into either steel tubes or hollow cylindrical sandstone specimens. The steel tubes measured 38 mm in outer diameter and 50 mm in depth, with a central cavity of 25 mm in diameter and 50 mm deep. For the sandstone specimens, cylinders with a 50 mm diameter and 50 mm height were drilled to the same dimensions (25 mm diameter×50 mm depth) to receive the cementitious materials. After curing, each specimen was placed under a steel loading block, and axial load was applied until debonding occurred, causing the steel tube or sandstone to separate from the cementitious core. Shear bond strength was then calculated by dividing the maximum applied load by the lateral contact surface area between the cementitious material and the surrounding substrate.

### Normal Bond Strength

As illustrated in FIG. 32 the normal bond strength between the cementitious material and steel was evaluated using a pull-off adhesion test following ASTM D7522. Six circular steel plates (Ø50 mm×2.7 mm) were positioned at the bottom of a rectangular mold measuring 250×175×20 mm, onto which either mortar or UHD-CMP was cast. After 24 hours of initial curing, the specimens were demolded and placed in their designated curing environments for 27 days. To isolate the bonded interface, a hole-saw was used to drill around each steel plate, exposing the portion embedded in the cementitious matrix. A pull-off dolly was then affixed to the steel plate with epoxy for attachment to the adhesion tester. A direct tensile load was applied perpendicular to the interface at a controlled rate of 0.017 MPa/s to determine the normal bond strength.

### Results and Discussion

### Physical Properties

### Drying Shrinkage

FIGS. 33A-33B compares drying shrinkage behavior over 90 days for both conventional mortars and UHD-CMP mixtures. Conventional mortars exhibited rapid shrinkage within the first 28 days, stabilizing afterward. At 90 days, M1 showed the highest shrinkage at approximately 888με, and M2 and M3 showed slightly lower shrinkage, with approximately 3.4% and 5.7% reductions, respectively, compared to M1. This reduction is attributed to their higher w/b ratios and improved internal moisture retention. In contrast, UHD-CMP mixtures exhibited higher shrinkage, primarily due to autogenous shrinkage associated with high cement content. For instance, U1 reached approximately 1482με at 90 days, which was 83% higher than the maximum shrinkage observed in the conventional mortar mixture M1. Furthermore, UHD-CMP shrinkage continued increasing beyond 28 days, reflecting ongoing self-desiccation related to their refined microstructure and denser matrix. U2 and U3 exhibited slightly lower shrinkage than U1, reaching approximately 1271με and 1230με, respectively.

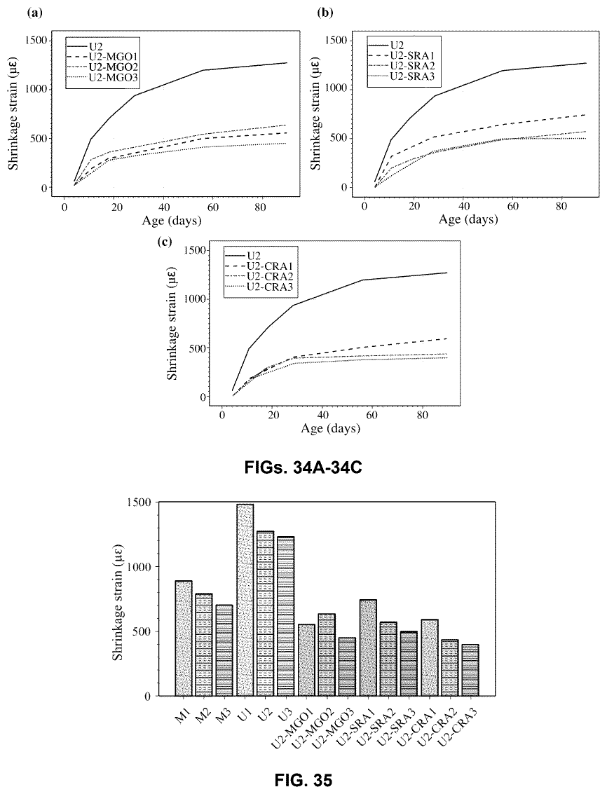

FIGS. 34A-34C present the shrinkage behavior of mix U2 modified with shrinkage-reducing admixtures (MgO, SRA, and CRA). All three admixtures led to reductions in drying shrinkage, with lower values observed at higher dosages. MgO-modified mixtures exhibited shrinkage values of 554με, 635με, and 448με for U2-MGO1, U2-MGO2, and U2-MGO3, respectively. These results are attributed to the expansive hydration of MgO, which offsets the internal tensile stresses caused by self-desiccation. SRA-modified mixtures showed shrinkage values of 743με, 570με, and 601με for U2-SRA1, U2-SRA2, and U2-SRA3 due to the reduction of capillary tension and slower moisture loss facilitated by the admixture's surfactant properties. CRA-modified mixtures recorded the lowest shrinkage with U2-CRA3 reaching 395με, which is associated with CaO-based expansion during hydration that contributes to dimensional compensation.

FIG. 35 presents a comparative summary of the average 90-day drying shrinkage strains for all tested materials. Conventional mortars exhibited lower shrinkage strains, likely due to their higher w/b ratios, while UHD-CMP mixtures showed increased shrinkage attributed to autogenous shrinkage resulting from their high cement content. The addition of shrinkage-reducing admixtures was necessary to control shrinkage in UHD-CMP formulations. Among the admixtures tested, CRA produced the lowest shrinkage values, followed by MgO and SRA. These results underscore the need for effective shrinkage control strategies to maintain dimensional stability in UHD-CMP while retaining its mechanical strength and durability

### Porosity

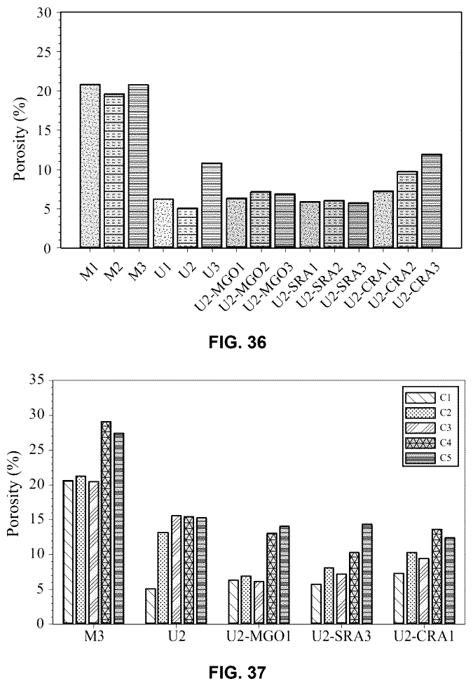

FIG. 36 presents the porosity of conventional mortars and UHD-CMP under standard curing (C1) obtained using helium porosimetry testing. The conventional mortars (M1-M3) showed similar porosity levels ranging from 18% to 21%, with M3 exhibiting the highest at 20.7%. Despite slight differences in w/b ratios, their high porosity is attributed to the use of coarser materials and fewer fines, resulting in limited microstructural densification. This result aligns with previous studies that found minimal porosity variation among conventional mortar mixes across different w/b ratios. UHD-CMP samples, however, exhibited reduced porosity due to their formulation, which includes finer powders, a low w/b ratio of 0.18, and pozzolanic/nano-scale additives. These factors contribute to continued hydration and a denser microstructure. The U2 demonstrated the lowest measured porosity at 4.8%. Slight increases in porosity were observed in UHD-CMP mixes containing shrinkage-reducing agents, with values of 6.1% for U2-MGO1, 5.8% for U2-SRA3, and 7.1% for U2-CRA1. The SRA-based admixture likely introduced micro-air voids and delayed early hydration, leading to modest porosity increases though such additives may promote later-stage refinement of the pore network through denser C—S—H formation. MgO-based expansion agents increased porosity due to their high water demand and the formation of low-density Mg(OH)₂. While high dosages (>5%) can raise porosity by over 10%, the moderate level used here limited this effect. Similarly, CaO-based agents elevated porosity by reducing microstructural density and requiring additional water to maintain workability.

FIG. 37 compares porosity changes in selected mixtures (M3, U2, U2-MGO1, U2-SRA3, U2-CRA1) under curing conditions (C1-C5). These mixtures were selected based on their low porosity under standard curing (C1). Under prolonged moisture exposure (C2), M3 maintained a porosity of 21.4%, nearly unchanged from C1. UHD-CMP samples showed increased porosity under the same condition; for example, U2's porosity rose from 4.8% (C1) to 13.2% (C2), a relative increase of approximately 175%. This change may be associated with moisture sensitivity of additives, or redistribution of early hydration products. Among the UHD-CMP mixtures, U2-MGO1 exhibited the lowest porosity at 7.0% under C2 conditions. Under cyclic wet-dry curing (C3), U2 exhibited higher porosity compared to C1, potentially due to internal stresses generated by repeated drying and wetting cycles. U2-MGO1 again recorded the lowest porosity among the UHD-CMP samples under these conditions, possibly due to expansion from MgO hydration partially offsetting microstructural disruption. Exposure to elevated temperatures (C4 and C5) led to increased porosity across all samples. M3 exhibited the highest values, reaching 29.1% under C4 and 27.4% under C5, likely due to evaporation of loosely bound water, moisture loss exceeding hydration, and potential redistribution or incomplete formation of hydration products. UHD-CMP mixtures also showed increased porosity under these conditions, ranging from 10.3% (U2-SRA3) to 15.3% (U2) at C4. Under C5, porosity values for all UHD-CMP mixtures converged around 13%. These temperature conditions may have influenced moisture transport and internal curing efficiency, contributing to the observed porosity changes. It is important to note that porosity and permeability are not linearly proportional; a small reduction in porosity can result in an order-of-magnitude decrease in permeability.

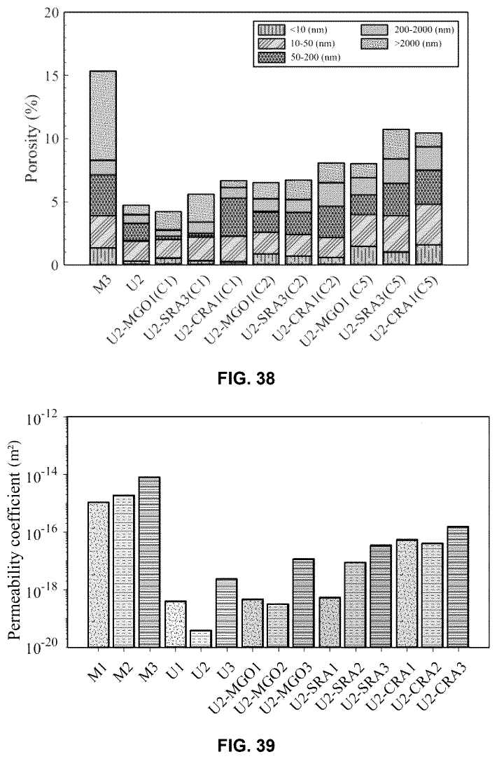

FIG. 38 presents the pore size distribution of selected samples (U2-MGO1, U2-SRA3, U2-CRA1) cured under conditions C1, C2, and C5 measured using MIP with M3 and U2 included as references. Total porosity was consistently lower than that obtained using helium porosimetry. This difference is attributed to the variation in pore size detection ranges: helium porosimetry captures pores as small as 0.22 nm, including gel pores within the C—S—H phase, whereas the lower detection limit of MIP in this study was approximately 5 nm. As noted by Jennings et al., MIP predominantly measures larger capillary and inter-granular pores (˜10 nm to >2000 nm), and may underestimate total porosity. Conventional mortar M3 exhibited the highest total pore volume, with a distribution dominated by pores greater than 2000 nm. In contrast, UHD-CMP samples showed a finer pore structure, primarily consisting of pores smaller than 200 nm. Among these, U2-MGO1 (C1) exhibited the lowest measured porosity, agreeing with the hypothesis on formation of additional hydration products induced by MgO. U2-CRA1 displayed a broader pore size distribution, with increased volumes in the 50-200 nm range, which may be associated with microstructural changes induced by CaO-based expansive reactions. Under elevated temperature conditions (C5), all UHD-CMP mixtures showed a shift toward coarser pore structures, with increased volumes of both large pores (>2000 nm) and intermediate capillary pores (50-200 nm). For instance, the pore volume fraction above 2000 nm in U2-SRA3 increased from 1.49% for C1 to 2.38% for C5 similar to an increase in the gel pore volume (<10 nm) in U2-CRA1. These changes are likely due to thermal degradation of hydration products, thermal expansion mismatch, and partial dehydration of the cementitious matrix, which together contribute to alterations in the pore network.

### Gas Permeability

FIG. 39 presents the gas permeability measurements through the bulk material for all tested mixtures under standard curing conditions (C1). Conventional mortars (M1-M3) exhibited permeability values in the range of 10⁻¹⁵ to 10⁻¹⁴ m², with M3 showing the highest value at 7.82×10⁻¹⁵ m². In comparison, UHD-CMP samples exhibited a lower permeability, ranging from 10⁻¹⁶ to 10⁻²⁰ m². Among these, U2 showed the lowest measured permeability at 4.05×10⁻²⁰ m², corresponding to its dense microstructure and low porosity. The incorporation of shrinkage-reducing admixtures (MgO, SRA, CRA) led to moderate increases in permeability. U2-MGO1 and U2-SRA1 showed permeability values of 4.79×10⁻¹⁹ m² and 5.41×10⁻¹⁹ m², respectively, while U2-CRA3 exhibited a higher value of 1.58×10⁻¹⁶ m². Despite these increases, all UHD-CMP formulations exhibited permeability values two to five orders of magnitude lower than those of the conventional mortars, indicating reduced gas transport through the bulk material.

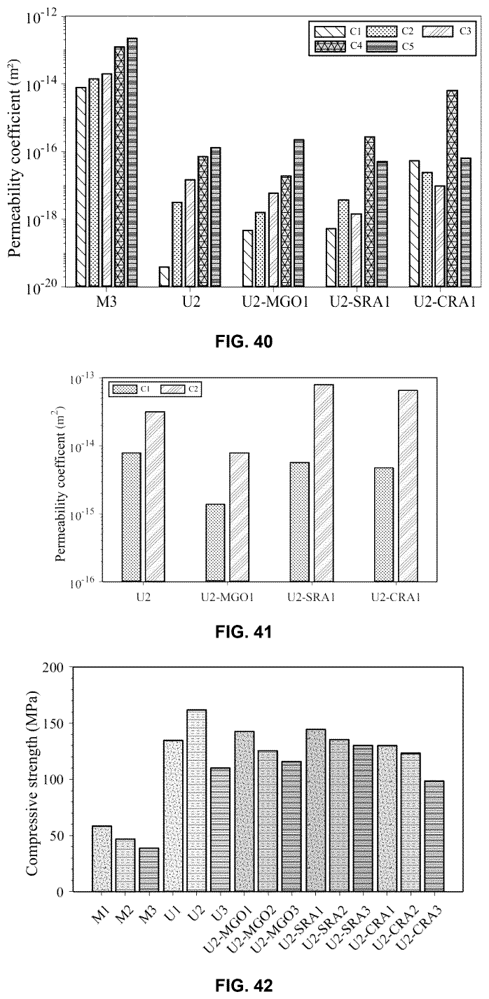

FIG. 40 presents the gas permeability of selected samples (M3, U2, U2-MGO1, U2-SRA1, U2-CRA1) subjected to curing conditions (C1-C5). M3 exhibited the highest permeability values, increasing from 7.82×10⁻¹⁵ m² under C1 to 2.25×10⁻¹³ m² under C5. Without wishing to be bound by any theory, this trend is attributed to moisture-driven degradation and thermal cracking under elevated temperature conditions. UHD-CMP samples also experienced increases in permeability under the same conditions, but the values remained lower than those observed for the conventional mortar. The baseline UHD-CMP mix (U2) showed an increase from 3.98×10⁻²⁰ m² (C1) to 1.35×10⁻¹⁶ m² (C5). The MgO-modified mixture (U2-MGO1) followed a similar trend, with permeability values suggesting relatively stable performance across the curing conditions evaluated. The SRA-based mixture (U2-SRA1) maintained low permeability values (on the order of 10⁻¹⁸ m²) under reduced humidity (C2) and cyclic curing (C3). However, permeability increased under elevated temperatures (C4 and C5), possibly due to changes in the microstructure induced by the early presence of the surfactant, which may have affected long-term pore connectivity or stability. The CaO-based expansive admixture (U2-CRA1) showed an increase in permeability from 5.41×10⁻¹⁷ m² under standard curing (C1) to the highest recorded value of 6.51×10⁻¹⁵ m² (C4). While all UHD-CMP mixtures exhibited increased permeability under harsher curing conditions, they remained more resistant to gas transport than the conventional mortar, indicating their potential suitability for applications requiring low permeability in aggressive environments.

FIG. 41 presents the gas permeability measurements at the UHD-CMP-steel interface for selected samples (U2, U2-MGO1, U2-SRA1, and U2-CRA1) under standard curing (C1) and reduced humidity conditions (C2). These mixtures were selected based on their bulk permeability performance to evaluate their effectiveness in sealing the cement-steel interface. Initial tests on conventional mortars (M1, M2, and M3) showed permeability values exceeding the maximum detection limit of the equipment, suggesting insufficient bonding and the presence of interfacial gaps. Consequently, conventional mortars were considered ineffective for ensuring interfacial impermeability. Under standard curing (C1), UHD-CMP samples exhibited a low permeability at the UHD-CMP-steel interface, with U2-MGO1 recording the lowest value at 1.31×10⁻¹⁵ m². This reduction may be associated with the expansive behavior of MgO hydration products, which can reduce interfacial voids and enhance contact with the steel substrate. Other UHD-CMP mixtures (U2, U2-SRA1, and U2-CRA1) also demonstrated similarly low permeability values under C1 conditions. When exposed to C2 (70% RH), all UHD-CMP mixtures experienced moderate increases in interfacial permeability. This is likely due to partial drying, which can restrict ongoing hydration, and cause shrinkage or microcracking, thereby increasing pore connectivity. U2-MGO1 maintained the lowest measured permeability at 7.73×10⁻¹⁵ m² under C2, indicating greater stability relative to the other mixes. These findings suggest that the UHD-CMP-steel interfacial permeability is influenced by moisture exposure and curing conditions. UHD-CMP formulations incorporating MgO showed lower interfacial permeability across both curing regimes and may offer advantages in applications requiring reduced gas transmission at bonded interfaces.

### Mechanical Performance

### Compressive Strength

FIG. 42 presents the 28-day compressive strength results for all tested materials. UHD-CMP mixes (U1, U2, U3) exhibited compressive strengths ranging from 109 MPa to 162 MPa, approximately three times greater than those of conventional mortars, which ranged from 40 MPa to 58 MPa. U2 showed the highest compressive strength at 162 MPa, followed by U1 (136 MPa) and U3 (109 MPa). These values are attributed to the low w/b ratio of 0.18, the use of dense particle packing based on the MMA model, and the incorporation of silica fume and silica powder, which together promote a denser matrix and additional pozzolanic reactions. Conventional mortars exhibited decreasing strength with increasing w/b ratios, which is consistent with prior experience indicating that higher water content increases porosity and negatively affects the microstructure. The incorporation of shrinkage-reducing admixtures (MgO, SRA, CRA) in UHD-CMP mixes led to compressive strength reductions ranging from approximately 5% to 20%. Among the modified mixes, SRA-modified samples retained the highest compressive strengths (130-144 MPa), followed by MgO-modified (115-142 MPa) and CRA-modified samples (98-130 MPa). These reductions are consistent with previous studies suggesting that shrinkage-reducing admixtures may affect cement hydration kinetics or introduce internal stresses within the matrix.

### Shear Bond Strength

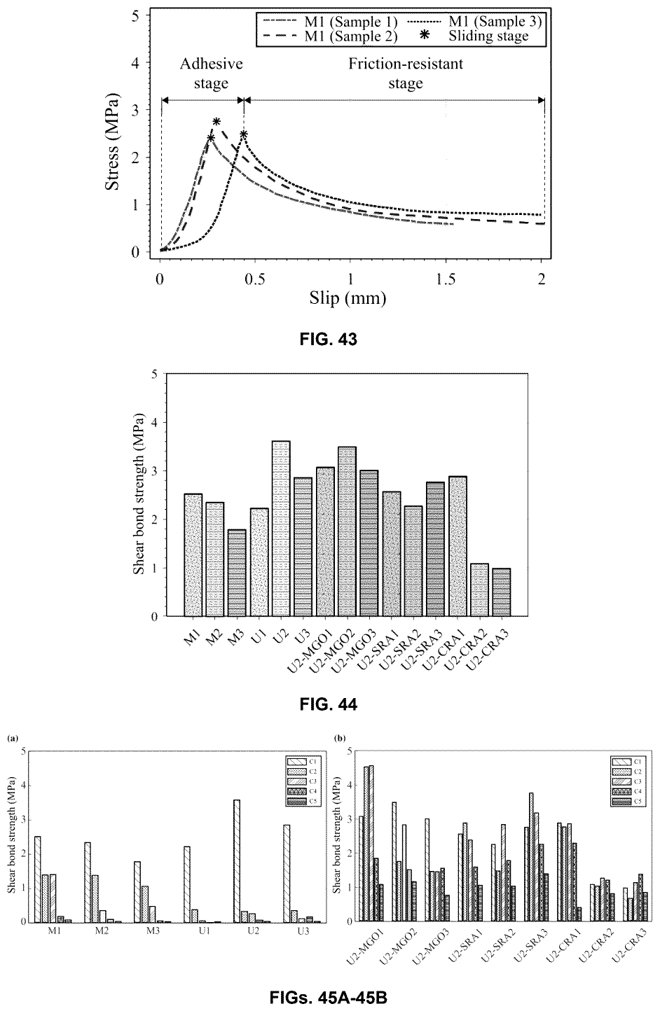

FIG. 43 illustrates the typical stress-slip response observed during the push-out testing of M1. The curve shows three characteristic stages: (i) an initial adhesive stage where slip is minimal and chemical adhesion governs the interaction at the mortar-steel interface; (ii) a short sliding stage, corresponding to peak stress and the onset of interfacial debonding; and (iii) a friction-dominated stage, where mechanical interlock and friction contribute to a gradual reduction in stress. This progression is consistent with the established interfacial bond models and reflects the typical failure sequence observed in cementitious material interfaces.

FIG. 44 compares the shear bond strengths of conventional mortars and UHD-CMP mixtures under standard curing conditions (C1). Conventional mortars exhibited bond strengths ranging from 1.79 MPa (M3) to 2.52 MPa (M1), which may be influenced by their lower cement content. UHD-CMP mixtures, on the other hand, showed higher bond strength values, with U2 reaching 3.58 MPa, representing a 42% increase over M1. This difference is attributed to the higher cement content of UHD-CMP and its effect on interfacial bonding. Among the modified UHD-CMP mixes, U2-MGO2 and U2-MGO1 recorded shear bond strengths of 3.49 MPa and 3.08 MPa, respectively. In comparison, mixes incorporating CaO-based shrinkage-reducing admixtures, such as U2-CRA2 (1.08 MPa) and U2-CRA3 (0.98 MPa), exhibited lower bond strengths. These values may be associated with microstructural changes at the interface, such as localized microcracking.

FIGS. 45A-45B present the shear bond strength of conventional mortars and UHD-CMP mixtures under various curing conditions (C1-C5). The results indicate that curing conditions have a measurable effect on interfacial bond performance. Conventional mortars experienced a 53.4% reduction in bond strength under low-humidity conditions (C2), while UHD-CMP mixtures exhibited further reductions, with average bond strength decreasing to approximately 0.35 MPa. Under elevated temperature conditions (C4), UHD-CMP bond strength values fell below 0.2 MPa, suggesting increased sensitivity to moisture loss and shrinkage in low-permeability systems. The addition of shrinkage-reducing admixtures influenced bond strength outcomes under these conditions. UHD-CMP samples modified with MgO or SRA maintained bond strengths comparable to or higher than those obtained under standard curing (C1). For example, under high-temperature curing (C4), bond strength in unmodified U2 was approximately 0.1 MPa, whereas values exceeded 2 MPa when modified with MgO or SRA. CRA-modified mixtures showed less improvement across all curing conditions. These findings emphasize the role of admixture selection and dosage optimization in managing shrinkage effects and maintaining bond strength under variable environmental conditions.

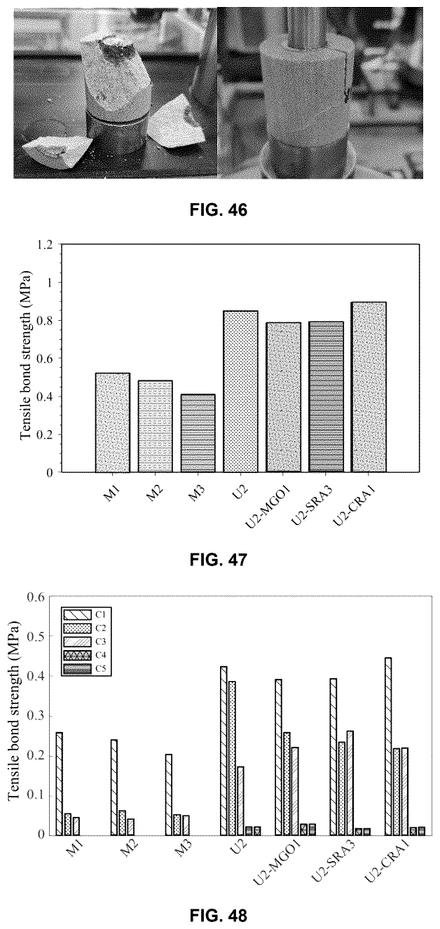

FIG. 46 presents shear bond test results for sandstone-mortar and sandstone-UHD-CMP interfaces, where failure occurred in the sandstone substrate rather than at the interface. Both systems exceeded the sandstone's compressive strength (>9.7 MPa), preventing direct measurement of interfacial bond strength but confirming that the interface was not the weak point in the plugging system. Similar substrate failures have been reported by other researchers, reinforcing the conclusion that the compressive strength of the sandstone was insufficient to withstand the applied loads. The dry condition of the sandstone prior to casting likely contributed to the high bond strength, as dry substrates are known to bond more effectively with hydraulic lime or natural cement mortars. In contrast, pre-wetting has been shown to reduce bond strength, particularly for binders with lower levels of hydraulic behavior.

### Normal Bond Strength

The normal (tensile) bond strength of mortar and UHD-CMP with steel under standard curing conditions (C1) is shown in FIG. 47 Only U2, U2-MGO1, U2-SRA3, and U2-CRA1 were tested, as prior shear bond tests identified them as the best-performing UHD-CMP mixtures. Conventional mortars (M1, M2, M3) exhibited an average bond strength of approximately 0.5 MPa, while the tested UHD-CMP samples showed higher average values around 0.8 MPa. Among them, U2-CRA1 had the highest measured bond strength at 0.90 MPa.

The effect of curing conditions C1 through C5 on normal bond strength is shown in FIG. 48. Under C2 (prolonged moisture exposure), all samples exhibited lower tensile bond strength compared to standard curing (C1). Mortar samples showed a reduction to approximately 0.1 MPa, while UHD-CMP samples decreased to around 0.45 MPa. Similar reductions were observed under cyclic curing conditions (C3), with consistent decreases in bond strength for both material types. Under elevated temperature conditions (C4 and C5), both conventional mortars and UHD-CMP samples exhibited further reductions in tensile bond strength. In conventional mortars, bond strength dropped to nearly zero, with the steel plate separating from the mortar without requiring applied tensile load. UHD-CMP samples showed tensile bond strength values below 0.05 MPa under these conditions. This reduction in interfacial performance is attributed to thermal mismatch between steel and the cementitious materials. Steel has a coefficient of thermal expansion of approximately 16×10⁻⁶ K⁻¹, while hardened cement paste expands at a lower rate of around 10×10⁻⁶ K⁻¹. The resulting differential expansion at elevated temperatures can generate interfacial stresses, promoting detachment and bond degradation. Overall, curing condition C2 had a measurable impact on tensile bond strength for both mortar and UHD-CMP samples while elevated temperature curing (C4 and C5) produced more pronounced reductions. Additionally, no substantial differences were observed between UHD-CMP mixtures with different shrinkage-reducing admixtures, indicating that tensile bond strength was similarly affected across all UHD-CMP formulations under these conditions.

### Conclusions

This study evaluated the interface properties and sealing performance of a novel UHD-CMP compared to conventional mortars for use in oil and gas well plugging applications. Key methane leakage pathways through the bulk cement matrix, cementitious material-steel interface, and cementitious material-formation interface was examined under five simulated downhole curing regimes. Additionally, the effects of three shrinkage-reducing admixtures (MgO, SRA, and CRA) on the physical, microstructural, and interfacial performance of UHD-CMP were systematically investigated. Overall, UHD-CMP demonstrated enhanced durability, mechanical strength, and sealing ability under demanding conditions. The primary findings are summarized below.

UHD-CMP mixtures achieved compressive strengths up to 162 MPa, compared to 40-65 MPa for conventional mortars. This strength gain is attributed to the low w/b ratio, optimized particle packing, and the incorporation of silica fume and silica powder. Although higher dosages of shrinkage-reducing admixtures led to slight reductions in strength, all UHD-CMP mixtures maintained compressive strengths more than twice those of conventional mortars.

Due to autogenous effects associated with its low w/b ratio and dense matrix, UHD-CMP exhibited greater drying shrinkage than conventional mortars. The incorporation of shrinkage-reducing admixtures compensated for shrinkage, with the lowest values reaching approximately 75% of those measured in conventional mortars without admixtures.

UHD-CMP samples exhibited much lower porosity (down to 4.8%) and gas permeability (as low as 10⁻²⁰ m²) compared to conventional mortars, which averaged 20.4% porosity and 10⁻¹⁵ m² permeability under standard curing (C1). These properties remained relatively stable under reduced humidity and cyclic curing (C2-C3), while elevated temperatures (C4-C5) increased both porosity and permeability across all mixes. MgO-modified UHD-CMP showed the smallest change, indicating improved thermal stability.

Under standard curing (C1), UHD-CMP mixtures bonded to steel exhibited slightly higher average shear bond strength (˜2.8 MPa) than conventional mortars (˜2.2 MPa). Under elevated temperature or limited moisture conditions (C4-C5), UHD-CMP mixtures with MgO and SRA exhibited higher bond strengths (˜1.7 MPa) compared to conventional mortars (˜0.08 MPa).

UHD-CMP exhibited higher tensile bond strength than conventional mortar under standard curing conditions (0.8 MPa versus 0.5 MPa) and retained bonding capacity under elevated temperatures. In contrast, conventional mortars exhibited a significant reduction in tensile bond strength under thermal exposure, indicating better thermal compatibility of UHD-CMP with steel.

Both UHD-CMP and conventional mortars formed strong bonds with sandstone, with failure occurring consistently in the sandstone rather than at the cementitious material-rock interface. This outcome indicates that the cementitious material-formation interface is not the limiting factor in bond performance.

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed, specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that is possible are specifically contemplated unless specifically indicated to the contrary. Thus, if a class of components A, B, and C are disclosed and a class of components D, E, and F and an example of a combination composition A-D are disclosed, then even if each is not individually recited, each is individually and collectively contemplated. Thus, in this example, each of the combinations A-E, A-F, B-D, B-E, B—F, C-D, C-E, and C—F are specifically contemplated and should be considered disclosed from the disclosure of A, B, and C; D, E, and F; and the example combination A-D. Likewise, any subset or combination of these is also specifically contemplated and disclosed. Thus, for example, the sub-group of A-E, B—F, and C-E are specifically contemplated and should be considered disclosed from disclosure of A, B, and C; D, E, and F; and the example combination A-D. This concept applies to all aspects of this disclosure, including, but not limited to, steps in methods of making and using the disclosed compositions. Thus, if there are a variety of additional steps that can be performed, it is understood that each of these additional steps can be performed with any specific aspect or combination of aspects of the disclosed methods and that each such combination is specifically contemplated and should be considered disclosed.

### EXEMPLARY ASPECTS

Example 1. A concrete article comprising: a plurality of pores having an average pore diameter of less than 1 micron as measured using mercury intrusion porosimetry (MIP) with a pressure of less than 440 MPa and overall porosity of less than 15% measured using helium porosimetry, wherein the concrete article exhibits a gas permeability of 10⁻¹⁷ to 10⁻²² m² as measured under steady-state conditions (with an upstream chamber pressure of 0.31 MPa and a downstream chamber pressure of less than 5 Pa) and is configured to substantially prevent a gas leak.

Example 2. The concrete article of any one of the examples herein, particularly Example 1, formed from a composition comprising an amount of a binder composition and an amount of water, wherein the binder composition comprises a hydraulic cement and an amount of a further cementitious material, and wherein a weight ratio of water to the binder is from 0.1 to less than 0.35.

Example 3. The concrete article of any one of the examples herein, particularly Example 2, wherein the further cementitious material comprises silica fume, fly ash, metakaolin, bentonite, slag cement, rice husk ash, calcined shale, or any combination thereof.

Example 4. The concrete article of any one of the examples herein, particularly Example 2 or 3, wherein the composition further comprises an amount of aggregates having an average particle size less than or equal to 4.75 mm according to ASTM C33/C33M.

Example 5. The concrete article of any one of the examples herein, particularly Example 4, wherein at least a portion of the amount of aggregates has an average particle size equal to or less than 250 μm according to ASTM C33/C33M.

Example 6. The concrete article of any one of the examples herein, particularly Examples 4 or 5, wherein at least a portion of the amount of aggregates has an average particle size of equal to or less than 600 μm according to ASTM C33/C33M.

Example 7. The concrete article of any one of the examples herein, particularly Examples 2-6, wherein the composition further comprises a plurality of fibers.

Example 8. The concrete article of any one of the examples herein, particularly Example 7, wherein the plurality of fibers comprises a metallic material, a polymeric material, a carbon material, a natural material, or any combination thereof.

Example 9. The concrete article of any one of the examples herein, particularly Example 7 or 8, wherein the plurality of fibers is substantially homogeneously distributed within the composition.

Example 10. The concrete article of any one of the examples herein, particularly Examples 2-9, wherein the composition further comprises an amount of active agents and/or reagents, fillers, or any combination thereof.

Example 11. The concrete article of any one of the examples herein, particularly Example 10, wherein the active agent and/or reagent comprises a water reducer, a set retarder, a shrinkage-reducing admixture, workability retaining admixture, or any combination thereof.

Example 12. The concrete article of any one of the examples herein, particularly Example 10 or 11, wherein the filler comprises a silica powder, a limestone powder, or any combination thereof.

Example 13. The concrete article of any one of the examples herein, particularly Examples 1-12, wherein the article exhibits a compressive strength of greater than 60 MPa to 200 MPa, prepared, cured, and tested according to ASTM C109/C109M.

Example 14. The concrete article of any one of the examples herein, particularly Examples 1-13, wherein the article is a ground-hole article.

Example 15. The concrete article of any one of the examples herein, particularly Examples 1-14, wherein the article is a wellbore article.

Example 16. The concrete article of any one of the examples herein, particularly Example 15, wherein the wellbore article comprises a packing between a wellbore casing and an earth formation, a plug, or any combination thereof.

Example 17. The concrete article of any one of the examples herein, particularly Examples 1-14, wherein the article is a component of a gas storage facility.

Example 18. The concrete article of any one of the examples herein, particularly Example 17, wherein the gas storage facility is configured to store one or more of natural gas, methane, propane, butane, carbon dioxide, or any combination thereof.

Example 19. The concrete article of any one of the examples herein, particularly Examples 17 or 18, where the gas storage facility is positioned at least partially underground.

Example 20. The concrete article of any one of the examples herein, particularly Examples 1-14, wherein the article is a radioactive material storage or a part of a nuclear component or facility.

Example 21. A method of making the concrete article of any one of the examples herein, particularly Examples 1-20, wherein the method comprises mixing a binder composition with an amount of water to form a slurry, wherein the binder composition comprises an amount of cement and cementitious materials, and wherein a weight ratio of water to the binder composition is from 0.1 to less than 0.35.

Example 22. The method of any one of the examples herein, particularly Example 21, wherein the cementitious material comprises silica fume, fly ash, metakaolin, bentonite, slag cement, rice husk ash, calcined shale, or any combination thereof.

Example 23. The method of any one of the examples herein, particularly Example 21 or 22, wherein the binder composition is mixed with an amount of aggregates having an average particle size less than or equal to 4.75 mm (measured according to ASTM C33/C33M) prior to mixing with water.

Example 24. The method of any one of the examples herein, particularly Example 23, wherein at least a portion of the amount of aggregates has an average particle size equal to or less than 250 μm measured according to ASTM C33/C33M.

Example 25. The method of any one of the examples herein, particularly Examples 21-23, wherein at least a portion of the amount of aggregates has an average particle size equal to or less than 600 μm measured according to ASTM C33/C33M.

Example 26. The method of any one of the examples herein, particularly Examples 21-25, wherein the slurry further comprises a plurality of fibers.

Example 27. The method of any one of the examples herein, particularly Example 25, wherein the plurality of fibers comprises a metallic material, a polymeric material, a carbon material, a natural material, or any combination thereof.

Example 28. The method of any one of the examples herein, particularly Examples 21-26, wherein the slurry further comprises an amount of active agents and/or reagents, fillers, or any combination thereof.

Example 29. The method of Example 28, wherein the active agent and/or reagent comprises a water reducer, a set retarder, a shrinkage reducing admixture, workability retaining admixture, or any combination thereof.

Example 30. The method of any one of the examples herein, particularly Example 28 or 29, wherein the filler comprises a silica powder, a limestone powder, or any combination thereof.

Example 31. The method of any one of the examples herein, particularly Examples 26-30, wherein the plurality of fibers, the active agents and/or reagents, fillers, or any combination thereof are mixed with the binder composition prior to mixing with water, mixed with water prior to mixing it with the binder composition, or separately added to the slurry.

Example 32. The method of any one of the examples herein, particularly Example 31, wherein at least one of the active agents is added to the amount of water before mixing it with the binder composition.

Example 33. The method of any one of the examples herein, particularly Examples 31 or 32, wherein the plurality of fibers are added to the slurry after mixing the binder composition with water.

Example 34. The method of any one of the examples herein, particularly Examples 26-33, wherein the plurality of fibers is added such that they are substantially homogeneously distributed within the slurry.

Example 35. The method of any one of the examples herein, particularly Examples 21-34, further comprising disposing the slurry into a mold to form the article.

Example 36. The method of any one of the examples herein, particularly Example 35, wherein the step of disposing of comprises casting the slurry, pumping the slurry, or any combination thereof.

Example 37. An article formed by methods of any one of the examples herein, particularly Examples 21-36.

Example 38. A concrete article comprising: a composition comprising: (a) a binder composition comprising: (i) 1 part by weight of a hydraulic cement; and (ii) 0.15 to 0.4 parts by weight of a further cementitious material based the weight of the hydraulic cement; and b) optionally 0.1 to 0.35 parts by weight of a filler based on the weight of the hydraulic cement; c) 0-1 parts by weight of aggregates based on the weight of the hydraulic cement, wherein the aggregates have an average size of greater than 0 to equal to or less than 2 mm; d) 0.1-0.35 parts by weight of water based on the weight of the binder composition; e) greater than zero to less than 0.15 parts by weight of one or more active agents based on the weight of binder composition; and f) less than 5% by volume of total material volume of a plurality of fibers, wherein the concrete article has a plurality of pores having an average pore diameter of less than 1 micron as measured using mercury intrusion porosimetry (MIP) with a pressure less than 440 MPa and an overall porosity of less than 15% measured using helium porosimetry.

Example 39. A composition comprising: (a) 1 part by weight of a hydraulic cement (b) 0.15-0.4 parts by weight based on the weight of the hydraulic of a cement additive comprising silica fume, fly ash, slag, metakaolin, bentonite, silica powder, rice husk ash, calcined shale or a combination thereof; (c) 0-1 parts by weight of aggregates based on the weight of the hydraulic cement, wherein the aggregates comprise: (i) 0.08-0.15 parts by weight of aggregates having an average particle size equal to or less than 250 μm measured based on ASTM C33/C33M; (ii) 0.28-0.4 parts by weight of aggregates having an average particle size equal to or less than 600 μm measured based on ASTM C33/C33M; and (iii) 0.45-0.75 parts by weight of aggregates having an average particle size equal to or less than 4.75 mm measured based on ASTM C33/C33M; (d) 0.1-0.35 parts by weight of water based on the weight of the binder composition comprised of a) and b); (e) greater than zero to less than 5% by volume of total material volume of a plurality of fibers; and (f) 0-0.15 parts by weight of one or more reactive agents based on the weight of the hydraulic cement.

Example 40. An article comprising a composition of any one of the examples herein, particularly Example 39.

Example 41. A wellbore comprising an article of any one of the examples herein, particularly Examples 1-20, 37, 38, or 40.

Example 42. A gas storage facility comprising an article of any one of the examples herein, particularly Examples 1-20, 37, 38, or 40.

Example 43. A radioactive material storage or a part of a nuclear component or facility comprising an article of any one of the examples herein, particularly Examples 1-20, 37, 38, or 40.

What is claimed is:

1. A concrete article comprising:
a plurality of pores having an average pore diameter of less than 1 micron as measured using mercury intrusion porosimetry (MIP) with a pressure of less than 440 MPa and overall porosity of less than 15% measured using helium porosimetry, and
wherein the concrete article exhibits a gas permeability of 10⁻¹⁷ to 10⁻²² m² as measured under steady-state conditions (with an upstream chamber pressure of 0.31 MPa and a downstream chamber pressure of less than 5 Pa) and is configured to substantially prevent a gas leak.

2. The concrete article of claim 1, formed from a composition comprising an amount of a binder composition and an amount of water, wherein the binder composition comprises a hydraulic cement and an amount of a further cementitious material, and wherein a weight ratio of water to the binder is from 0.1 to less than 0.35.

3. The concrete article of claim 2, wherein the further cementitious material comprises silica fume, fly ash, metakaolin, bentonite, slag cement, rice husk ash, calcined shale, or any combination thereof.

4. The concrete article of claim 2, wherein the composition further comprises:
an amount of aggregates having an average particle size less than or equal to 4.75 mm according to ASTM C33/C33M;
wherein at least a portion of the amount of aggregates has an average particle size equal to or less than 250 μm according to ASTM C33/C33M; and/or
wherein at least a portion of the amount of aggregates has an average particle size of equal to or less than 600 μm according to ASTM C33/C33M.

5. The concrete article of claim 2, wherein the composition further comprises a plurality of fibers, wherein the plurality of fibers comprises a metallic material, a polymeric material, a carbon material, a natural material, or any combination thereof, and wherein the plurality of fibers is substantially homogeneously distributed within the composition.

6. The concrete article of claim 2, wherein the composition further comprises;
an amount of active agents and/or reagents comprising a water reducer, a set retarder, a shrinkage reducing admixture, a workability retaining admixture, or any combination thereof; and/or
an amount of fillers, wherein the fillers comprise a silica powder, a limestone powder, or any combination thereof.

7. The concrete article of claim 1, wherein the article exhibits a compressive strength between 60 MPa to 200 MPa, prepared, cured, and tested according to ASTM C109/C109M.

8. The concrete article of claim 1, wherein the article is a ground-hole article, a wellbore article, a component of a gas storage facility, a component of radioactive material storage, or a part of a nuclear component or facility, or a combination thereof.

9. The concrete article of claim 8, wherein the wellbore article comprises a packing between a wellbore casing and an earth formation, a plug, or any combination thereof.

10. The concrete article of claim 8, wherein the gas storage facility is configured to store one or more of natural gas, methane, propane, butane, carbon dioxide, or any combination thereof.

11. The concrete article of claim 8, where the gas storage facility is positioned at least partially underground.

12. A method of making the concrete article of claim 1, wherein the method comprises:
mixing a binder composition with an amount of water to form a slurry, wherein the binder composition comprises an amount of cement and cementitious materials, and wherein a weight ratio of water to the binder composition is from 0.1 to less than 0.35.

13. The method of claim 12, wherein the cementitious material comprises silica fume, fly ash, metakaolin, bentonite, slag cement, rice husk ash, calcined shale, or any combination thereof.

14. The method of claim 12, wherein the binder composition is mixed with an amount of aggregates having an average particle size less than or equal to 4.75 mm (measured according to ASTM C33/C33M) prior to mixing with water; wherein
at least a portion of the amount of aggregates has an average particle size equal to or less than 250 μm according to ASTM C33/C33M, and/or wherein at least a portion of the amount of aggregates has an average particle size of equal to or less than 600 μm according to ASTM C33/C33M.

15. The method of claim 12,
wherein the slurry further comprises:
a plurality of fibers comprising a metallic material, a polymeric material, a carbon material, a natural material, or any combination thereof; and/or
wherein the slurry further comprises:
an amount of active agents and/or reagents comprising a water reducer, a set retarder, a shrinkage reducing admixture, a workability retaining admixture, or any combination thereof; and/or
an amount of fillers, wherein the fillers comprise a silica powder, a limestone powder, or any combination thereof.

16. The method of claim 15, wherein the plurality of fibers, the active agents and/or reagents, fillers, or any combination thereof are mixed with the binder composition prior to mixing with water, mixed with water prior to mixing it with the binder composition, or separately added to the slurry.

17. A concrete article comprising:
a composition comprising:
a) a binder composition comprising:
i) 1 part by weight of a hydraulic cement; and
ii) 0.15 to 0.4 parts by weight of a cementitious material based on the weight of the hydraulic cement; and
b) optionally 0.1 to 0.35 parts by weight of a filler based on the weight of the hydraulic cement;
c) 0-1 parts by weight of aggregates based on the weight of the hydraulic cement, wherein the aggregates have an average size of greater than 0 to equal to or less than 2 mm;
d) 0.1-0.35 parts by weight of water based on the weight of the binder composition;
e) greater than zero to less than 0.15 parts by weight of one or more active agents based on the weight of binder composition; and
f) less than 5% by volume of total material volume of a plurality of fibers,
wherein the concrete article has a plurality of pores having an average pore diameter of less than 1 micron as measured using mercury intrusion porosimetry (MIP) with a pressure of less than 440 MPa and an overall porosity of less than 15% measured using helium porosimetry.

18. A composition comprising:
a) 1 part by weight of a hydraulic cement
b) 0.15-0.4 parts by weight based on the weight of the hydraulic of a cement additive comprising silica fume, fly ash, slag, metakaolin, bentonite, silica powder, rice husk ash, calcined shale, or a combination thereof;
c) 0-1 parts by weight of aggregates based on the weight of the hydraulic cement, wherein the aggregates comprise:
i) 0.08-0.15 parts by weight of aggregates having an average particle size equal to or less than 250 μm measured based on ASTM C33/C33M;
ii) 0.28-0.4 parts by weight of aggregates having an average particle size equal to or less than 600 μm measured based on ASTM C33/C33M; and
iii) 0.45-0.75 parts by weight of aggregates having an average particle size equal to or less than 4.75 mm measured based on ASTM C33/C33M;
d) 0.1-0.35 parts by weight of water based on the weight of the binder composition comprised of a) and b);
e) greater than zero to less than 5% by volume of the total material volume of a plurality of fibers; and
f) 0-0.15 parts by weight of one or more reactive agents based on the weight of the hydraulic cement.

19. An article comprising a composition of claim 18.

20. A wellbore, a gas storage facility, and/or a radioactive material storage, or a part of a nuclear component or facility comprising the article of claim 1.
